(19) United States
(12) Patent Application Publication
(10) Pub. No.: US 2009/0174142 A1
(43) Pub. Date: Jul. 9, 2009

(54) Methods and apparatus for educational spelling games

(76) Inventor: Richard J. Sullivan, Hauppauge, NY (US)

Correspondence Address: Daniel P. Burke, Esq., Daniel P. Burke & Associates, PLLC, 300 Rabro Drive, Suite 131, Hauppauge, NY, 11788, US

(21) Appl. No.: 12/290,568

(22) Filed: Oct. 31, 2008

Related U.S. Application Data
(60) Provisional application No. 61/010,625, filed on Jan. 9, 2008.

(51) Int. Cl. A63F 3/00; G09B 19/22

(52) U.S. Cl. 273/272; 434/128

(57) ABSTRACT

Methods and apparatus for educational spelling games wherein players are required to spell words of various levels of spelling difficulty and a player's degree of advancement depends on the difficulty level of the word. One version is a game board with a plurality of playing pieces, a plurality of spelling cards, each spelling card comprising a plurality of spelling words wherein different words on each of those spelling cards comprise different levels of spelling difficulty within at least one educational grade level or age level, preferably within two consecutive educational grade levels, and a die for randomly determining the level of spelling difficulty of the word which a player will be asked to spell. Preferably, there are at least three words of different levels of spelling difficulty on each spelling card. Also disclosed are electronic versions comprising an annunciator to announce the words, game show versions, computer game versions and internet-based versions.

### RELATED APPLICATION DATA

This application claims the benefit under 35 U.S.C. §119(e) of U.S. Provisional Application Ser. No. 61/010,625 filed Jan. 9, 2008, which is hereby incorporated by reference as if repeated herein in its entirety.

The present invention is directed to educational games, and particularly to educational games that test a player's spelling ability and helps sharpen a player's spelling skills.

### BACKGROUND OF THE INVENTION

Games have previously been disclosed for testing players' knowledge including a player's spelling skills. In one previously disclosed game, a player is given the definition of a word and then must guess the defined word. If the player guesses the word correctly, he is then given the opportunity to spell it for a bonus. This game includes different decks of cards with each deck comprising words for given educational, intellectual and age levels so that players of different levels can play together.

In another previously disclosed spelling game, words are randomly selected from a word storage, e.g. a dictionary, for spelling by a player. In various embodiments, the list of words in the word storage may have one or more levels of spelling difficulty wherein the spelling difficulty is chosen by a player during his turn or is randomly determined. If the player spells a word correctly, he is awarded a number of points which can correspond to the level of difficulty of the spelling word. The purpose of the game is to accumulate the highest number of points. This game, however, is not a board game and does not disclose or suggest a plurality of different levels of spelling difficulty within at least one and no more than two consecutive educational grade levels or age levels.

### SUMMARY OF THE INVENTION

In order to provide greater challenges and games of greater interest, it is particularly desirable to provide a spelling game wherein words of different levels of spelling difficulty are provided within at least one and no more than two consecutive educational grade levels or age levels. It is desirable to have a spelling game that challenges a player to improve his spelling skills regardless of how accomplished the player is as a speller. It is also desirable to provide words of different levels of spelling difficulty in a given game level so that a player may randomly be required to spell words that are considered more difficult within a game level during any turn. It is also desirable to allow players who are of the same or nearly the same age or educational grade level to compete against each other using the same set of spelling words, while allowing players of a different age or grade level to play the game at the same time using a different set of spelling words appropriate for their age level or educational grade level.

Embodiments of the present invention are directed to educational spelling games wherein players are required to spell words of various levels of spelling difficulty within at least one and no more than two educational grade levels or age levels in order to advance. One embodiment comprises a game board, a plurality of playing pieces, a plurality of spelling cards each comprising a plurality of spelling words wherein different words on each of those spelling cards have different levels of spelling difficulty and, the different words are selected from spelling lists from at least one and no more than two consecutive educational grade levels or age levels, most preferably from two educational grade levels, and means for randomly determining the level of spelling difficulty of the word which a player will be asked to spell, e.g. a die, a spinner, or the like.

According to one embodiment, the plurality of spelling cards comprises words of different spelling difficulties within a specific educational grade level. Preferably, there are at least three words of different levels of spelling difficulty on each spelling card. This embodiment of the game comprises collections of cards comprising words of different spelling difficulties within a specific grade level. A single game level can cover no more than two consecutive ages and/or grade levels, e.g. ages 7-8 or grades 7-8. A plurality of card collections each corresponding to spelling words for different game levels may also be provided. For marketing purposes, such additional collections of spelling words may be made available separately.

Another embodiment of the present invention is an electronic version comprising an annunciator to announce the words. In a preferred electronic embodiment, the circuitry randomly determines the difficulty of the word to be spelled, selects a word of that difficulty from the plurality of difficulties within at least one and no more than two consecutive educational grade level or age level and then an annunciator announces the word to be spelled.

### BRIEF DESCRIPTION OF THE DRAWINGS

FIG. 1 is a top view of one embodiment of a game board of the present invention.

FIG. 2 is a top view of the word side of a “BUZZLEWORD Card” (spelling word card) of one embodiment of the present invention.

FIG. 3 is a top view of the direction side of a “BUZZLEBEE Card” of one embodiment of the present invention.

FIG. 4 is a top view of the direction side of a “BZ-PASS” card of one embodiment of the present invention;

FIG. 5 is a perspective view of an electronic embodiment of the present invention.

### DETAILED DESCRIPTION

One illustrated embodiment of the present invention comprises a board game which can be played by a plurality of players, e.g. 2-6 players, of educational grade level 1 and up. For example, children's versions of the present game are provided for each of grades 1-2, grades 3-4, grades 5-6, grades 7-8, and an adult version is for high school students through adults. For grades eight and lower, or ages 13 and lower, each game level preferably comprises no more than two consecutive grade educational levels of consecutive ages.

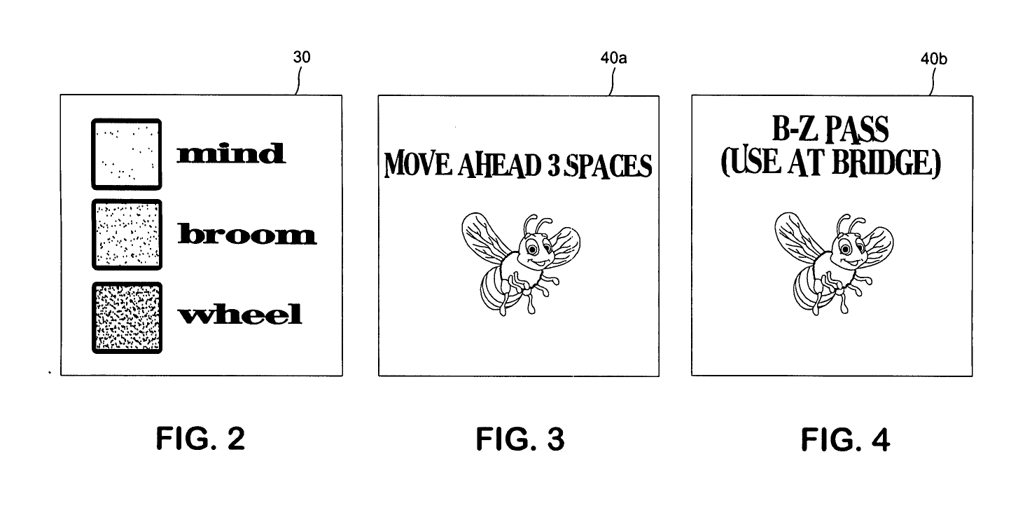

One illustrated embodiment of the game comprises a game board, three hundred spelling cards known as “BUZZLEWORD Cards” as shown in FIG. 2, designated for the specific game level, fifty “BUZZLEBEE” cards which direct player's moves and which are drawn by players who land on spaces designated as “BEE” spaces on the game board, and a tri-colored die for randomly determining the spelling difficulty of the word to be spelled for each player's turn. This embodiment also comprises a plurality of playing pieces for players to move along the game board. In one embodiment, the playing pieces are six bee-shaped figurines each of a different color to identify each different player.

During play, players may optionally be provided with a writing implement and paper to write down their spelling words. Also useful during play is a dictionary to consult for word derivation, definition and pronunciation. Use of a dictionary with the present game may advantageously sharpen players' reading and vocabulary skills, but is not required.

Each spelling card may be marked on one side with the game level of the spelling card and, optionally, a company logo. The other side of the spelling card contains a plurality of words of different difficulties, i.e. the spelling words. As indicated in FIG. 2, there are three words with three different indicia, wherein the different indicia refer to the spelling difficulty. Preferably, there are at least three spelling words on each card. The words on each spelling card are of different spelling difficulties identified herein as EASIER, INTERMEDIATE and MORE DIFFICULT. In one embodiment, the EASIER spelling words are denoted by a particular color, e.g. a yellow square preceding the word, the INTERMEDIATE spelling words are identified by a different color, e.g. a green square preceding the word, and the MORE DIFFICULT spelling words are identified by a third color, e.g. a blue square preceding the word. Some indicia must be provided for identifying the different levels of difficulty, but various indicia may be utilized including different symbols, colors, numbers, fonts, word order on the card, etc. In any event, some indicia other than the spelling words themselves is provided on the word side of the spelling cards to indicate their level of difficulty. The die or other random selector used to randomly determine the level of spelling difficulty a player's word will be on a particular turn will also preferably comprise indicia which corresponds to the indicia utilized on the card. According to other embodiments of the present invention, the word itself may be randomly selected. For example, in an electronic version, including a television version, or a computer based version, the word itself may be randomly selected, however, in such instances, the word will have been previously assigned a level of difficulty. Therefore, in such embodiments, the level of difficulty will also be selected randomly even though the device for doing the random selection is directed to the word itself rather than the level of difficulty. In such instances, for purposes of the present invention, both the word and the level of spelling difficulty are deemed to be randomly selected.

The words that are used on the spelling cards are most preferably from known spelling lists which include high frequency words suggested for teaching in each grade level. The term “known spelling lists” is used herein to indicate lists of spelling words found in a common source, e.g. on the world wide web or published in books. The term “grade level” is used herein to identify a single division of a school or a collection of persons grouped according to age or the same relative academic ability. According to this embodiment, the different grade levels include each of grades first through eighth grade. Such spelling lists exist for grades one through eight and are posted on the world wide web and are published in books. Examples of suitable spelling lists found on the world wide web include those found on the following web sites:
http://www.asij.ac.jp/elementary/gr1web/cla/100%20words.htm
http://www.wcusd15.org/ses/spelling2.htm
http://www.time4learning.com/SpellingWords/3rd-grade-spelling-words.shtml
http://www.time4learning.com/SpellingWords/4th-grade-spelling-words.shtml
http://www.ohsd.net/index2.cfm?page=_c2&cid1&cid2=179
http://aschilb.emsd37.org/Spelling/spellling2nd.htm
http://www.time4learning.com/SpellingWords/1st-grade-spelling-words.shtml
http://www.delano.k12.mn.us/sitepages/pid323.php
http://www.gowrie.k12.ia.us/3rdgrade/spelling.asp
http://web.dps.k12.va.us/ParkAve/spelling.htm
http://www.delano.k12.mn.us/sitepages/pid137.php
http://www.riverdale.k12.or.us/˜bblack/sp12.htm
http://www.riverdale.k12.or.us/˜bblack/sp11.htm
http://www.riverdale.k12.or.us/˜bblack/sp10.htm
http://www.riverdale.k12.or.us/˜bblack/sp9.htm
http://www.riverdale.k12.or.us/˜bblack/sp8.htm
http://www.riverdale.k12.or.us/˜bblack/sp7.htm
http://www.riverdale.k12.or.us/˜bblack/sp6.htm
http://www.riverdale.k12.or.us/˜bblack/sp5.htm
http://www.riverdale.k12.or.us/˜bblack/sp4.htm
http://www.riverdale.k12.or.us/˜bblack/sp3.htm
http://www.riverdale.k12.or.us/˜bblack/sp2.htm
http://www.riverdale.k12.or.us/˜bblack/sp16.htm
http://www.riverdale.k12.or.us/˜bblack/sp15.htm
http://www.riverdale.k12.or.us/˜bblack/sp14.htm
http://www.riverdale.k12.or.us/˜bblack/sp1.htm
http://www.time4learning.com/SpellingWords/5th-grade-spelling-words.shtml
http://boe.berk.k12.wv.us/217/tospell5.htm
http://www.riverdale.k12.or.us/˜bblack/sp13.htm
http://www.ohsd.net/index2.cfm?page=_c2&cid1=61&cid2=179
http://www.nhcs.k12.in.us/staff/bburson/webcreation/spelling/stormigiovanni.html
http://www.nhcs.k12.in.us/staff/bburson/webcreation/spelling/explodingants.html
http://www.nhcs.k12.in.us/staff/bburson/webcreation/spelling/stretchingourselves.html
http://www.nhcs.k12.in.us/staff/bburson/webcreation/spelling/westlandia.html
http://www.nhcs.k12.in.us/staff/bburson/webcreation/spelling/mahaliajackson.html
http://www.nhcs.k12.in.us/staff/bburson/webcreation/spelling/dinosaurshawkins.html
http://www.nhcs.k12.in.us/staff/bburson/webcreation/spelling/leonardoshorse.html
http://www.nhcs.k12.in.us/staff/bburson/webcreation/spelling/wingsforking.html
http://www.nhcs.k12.in.us/staff/bburson/webcreation/spelling/midnightride.html
http://www.nhcs.k12.in.us/staff/bburson/webcreation/spelling/janegoodall.html
http://www.nhcs.k12.in.us/staff/bburson/webcreation/spelling/passagefreedom.html
http://www.nhcs.k12.in.us/staff/bburson/webcreation/spelling/insideout.html
http://www.nhcs.k12.in.us/staff/bburson/webcreation/spelling/satchelpaige.html
http://www.nhcs.k12.in.us/staff/bburson/webcreation/spelling/islanddolphins.html
http://www.nhcs.k12.in.us/staff/bburson/webcreation/spelling/thunderrose.html
http://www.nhcs.k12.in.us/staff/bburson/webcreation/spelling/frindle.html
http://www.nhcs.k12.in.us/staff/bburson/webcreation/spelling/gymnast.html
http://www.nhcs.k12.in.us/staff/bburson/webcreation/spelling/chilinpurse.html
http://www.all-about-spelling.com/spelling-list-for-6th-grade.html
http://www.time4learning.com/SpellingWords/6th-grade-spelling-words.shtml
http://www.home2teach.com/Spelling5-6.html
http://www.time4learning.com/SpellingWords/7th-grade-spelling-words.shtml
http://www.time4learning.com/SpellingWords/8th-grade-spelling-words.shtml
http://www.justinrudd.com/adultbee.html

One embodiment comprises a plurality of decks of spelling cards. Each of the decks comprises words from two adjoining grade levels. The spelling cards for Level 1 comprise words from known spelling lists for first and second grade. Similarly, the spelling cards for Level 2 comprise words from known spelling lists for third and fourth grade; the spelling cards for Level 3 comprise words from known spelling lists for fifth and sixth grade; and spelling cards for Level 4 comprise words from known spelling lists for seventh and eighth grade. The spelling cards for the adult level version of the present game comprise words that are at a higher vocabulary level or higher spelling level than eighth grade and which are not commonly found on spelling lists for educational grades one through eight.

As noted above, the words on the spelling cards are categorized by the relative spelling difficulty of the words. Each spelling card has a plurality of spelling words on one side, and preferably at least three words following an EASIER, INTERMEDIATE and MORE DIFFICULT spelling difficulty arrangement. While these category titles are used herein, in an actual game, the categories can be titled “Difficult,” “More Difficult” and “Most Difficult” for the morale of the players. The difficulty of the spelling words may be determined by one or more of the criteria set forth in detail below. Tables 1-5 provide exemplary lists of possible spelling words set forth by game level and subdivided within each game level by spelling difficulty. Table 1 sets forth a spelling word list for Level 1, Table 2 sets forth a spelling word list for Level 2, Table 3 sets forth a spelling word list for Level 3, Table 4 sets forth a spelling word list for Level 4, and Table 5 sets forth a spelling word list for the adult level of the game.

TABLE 1
LEVEL 1 - 1^{ST} & 2^{ND} GRADE

| | | MORE |
|---|---|---|
| EASIER | INTERMEDIATE | DIFFICULT |
| mind | broom | wheel |
| map | serve | clue |
| hard | sixth | would (please) |
| base | team (group) | wear (put on) |
| pump | throw | sunny |
| wild | duck | write (pen) |
| salt | straw | blue (color) |
| hay | court | morning (a.m.) |
| mad | cloud | really |
| step | word | ahead |
| bark | off | slight |
| shut | tie | whole (all) |
| tray | least | already |
| book | extra | sea (water) |
| cool | bear (animal) | thumb |
| mile | tune | probably |
| frog | seal | half |
| fire | sore (hurt) | correct |
| loop | pane (glass) | window |
| hold | store | than (bigger) |
| home | never | funny |
| string | seat | before |
| clam | roast | ready |
| fool | crack | wrote (pen) |
| twig | use | above |
| melt | beach | cousin |
| star | ground | queen |
| long | floor | pie |
| took | mean | curve |
| bell | peek (look) | enough |
| win | sound | loose |
| hug | peach | one (1) |
| trip | crow | breeze |
| low | roar (lion) | circus |
| king | after | family |
| tent | roof | worm |
| day | story | chance |
| play | bird | coal |
| like | neat | scratch |
| deep | back | stitch |
| sky | found | squirt |
| woke | enter | yellow |
| most | quiz | goat |
| tame | burn | fence |
| talk | meal | gone |
| hike | false | woman |
| cold | bean | true |
| far | loud | night |
| bull | proud | watch |
| cry | work | useful |
| try | body | suit |
| gas | moon | chief |
| fork | chore | kitten |
| flip | shirt | earth |
| ink | drew | boat |
| list | space | sigh |
| ate (food) | race | because |
| born | earn (money) | sugar |
| stink | eat | mail (letter) |
| band | train | number |
| chop | stain | cheese |
| torn | your (belongs to) | again |
| date | park | summer |
| ant | what | when |
| yet | more | answer |
| chill | only | question |
| bend | ice | sure |
| bun | quilt | their (belongs to} |
| find | size | squeeze |
| such | house | paid |
| sank | room | white |
| gift | draw (art) | through (door) |
| side | soon | sour |
| spoke | table | choose |
| now | wait | towel |
| belt | frown | while |
| pig | silk | tease |
| hall | stew | vowel |
| cook | stick | sign |
| lane | live | guard |
| keep | mouse | said |
| late | rice | below |
| yard | chew | bright |
| drive | very | almost |
| bike | flew (bird) | daddy |
| fish | guy | laugh |
| spill | black | school |
| spend | prove | awful |
| gold | gain | always |
| must | aid | could |
| lost | spoon | should |
| choke | child | grown |
| bus (school) | cheat | mommy |
| harm | door | climb |
| full | gown | pretty |
| twist | quit | witch (broom) |
| went | candy | where (place) |
| wall | wise | believe |
| also | animal | shoe |
| walk | open | instead |
| much | own | dollar |
| rope | prize | cough |
| ship | out | guess |
| want | close (door) | light |
| fox | deal | minute |
| strong | egg | tea (drink) |
| shed | world | different |
| short | shout | eight (8) |
| time (clock) | boil | kneel |
| song | food | little |
| pay | dew (mist) | soften |
| pants | fifth | which (one) |
| damp | early | sight (eyes) |
| well | saw (looked) | dumb |
| tree | hose | choice |
| corn | heal (fix) | pour (milk) |
| stop | speed | fight |
| ago | real (true) | wrong |
| sun (sky) | those | dropped |
| bush | wood (tree) | whisper |
| make | sock | piece (part of) |
| big | pound | thought |
| fly | meat (food) | fruit |
| cow | stuff | rhyme |
| arm | fifty | high (up) |
| start | hair (head) | usually |
| bee (insect) | oil | once |
| thing | maybe | rough |
| chip | boot | eyes |
| doll | hurt | too (also) |
| kite | soil | waist (belt) |
| horn | skirt | lie (false) |
| shark | fair (o.k.) | niece |
| warm | dirt | two (2) |
| rake | horse (ride) | pail (bucket) |
| milk | pair (two) | scent (smell) |
| row | son (boy) | friend |
| sleep | pass | tale (story) |
| flag | coat | between |
| take | snore | blew (wind) |
| hive | made (bed) | bounce |
| dog | stair (step) | does |
| how | share | knot (rope) |
| fist | dear (sir) | surprise |
| chin | easy | cereal (food) |
| stamp | water | often |
| may | feet (socks) | sail (boat) |
| toss | sum (total) | some (part) |
| cost | mane (lion) | main (chief) |
| name | steal (take) | ounce |
| boss | teach | please |
| pot | couch | tail (wag) |
| card | change | wheat |
| man | front | guest |
| small | wore (clothes) | taught |
| land | weed | banana |
| vote | show | poem |
| dust | fail | honey |
| barn | taste | daughter |
| ray | icy | phone |
| sting | sister | scary |
| mom | worn (clothes) | idea |
| bank | first | busy |
| fast | girl | brother |
| bump | mark | goal |
| plan | kick | pea (pod) |
| sang | won (game) | soap |
| hope | teeth | beautiful |
| call | shake | breath |
| say | lose | against |
| joy | mess | across |
| dish | beast | done |
| bring | deer (animal) | pillow |
| six | love | bread |
| dig | around | tough |
| twin | flake | either |
| dark | field | behind |
| bag | over | view |
| bug | clean | picture |
| tell | fluff | patch |
| hang | clock | quiet |
| put | dial | glue |
| bone | feel | been (was) |
| beg | form | nothing |
| lake | sack | catch |
| all | about | since |
| men | scoop | soup |
| old | third | itch |
| joke | they | tight |
| ball | few | blood |
| got | away | wool |
| jet | second | color |
| jaw | feed | church |
| test | glass | flea (insect) |
| slip | under | cruel |
| thank | cream | during |
| spin | dream | flight |
| mild | mouth | none (not any) |
| nest | stone | many |
| boy | mister | goes |
| car | speak | there (place) |
| west | blow | touch |
| wash | clown | hungry |
| curb | fear | parent |
| tub | rail | hello |
| fog | peak (top) | sword |
| fix | flame | whip |
| sold | baby | wrist |
| wing | brake (car) | gently |
| snap | chase | ache |
| rush | raw (meat) | toes (foot) |
| wish | move | favorite |
| bent | froze | style |
| see (eyes) | chose | problem |
| cat | waste (garbage) | something |
| rude | hear (sound) | meant |
| shop | heel (foot) | money |
| crib | cheer | chalk |
| look | river | hour (time) |
| way | visit | silly |
| pet | beak | aunt |
| farm | next | threw (ball) |
| will | tooth | whose |
| glow | head | circle |
| with | place | children |
| brush | any | smooth |
| dress | shape | fought |
| both | exit | switch |
| just | uncle | birthday |
| less | slow | gloves |
| push | odd | prince |
| pest | green | follow |
| bite (teeth) | feast | serious |
| fall | zero | sew (hem) |
| paw (cat) | danger | thread |
| lamp | curl | build |
| pill | inch | voice |
| stem | truth | whisker |
| bad | leave | bought |
| cash | twice | station |
| dot | greet | alphabet |
| dad | rule | pencil |
| lump | tool | yesterday |
| sell | heat | pause (stop) |
| dash | come | every |
| box | east | great (good) |
| sand | coast | letter |
| set | float | pony |
| cake | sir | sale (less $) |
| fun | join | alright |
| top | jail | peace (calm) |
| sad | meet (me) | together |
| flash | root (tree) | right (correct) |
| free | rare | know (get it) |
| think | rain (clouds) | force |
| toy | buy (pay for) | pear (fruit) |
| trash | rock | thirsty |
| them | pain (hurt) | laid |
| ring (bell) | beat (drum) | puppy |
| gum | poor | marry |
| hog | pale (white) | city |
| lift | brain | bottom |
| rest | learn | someone |
| grow | empty | brought |
| into | street | knock |
| pool | cowboy | whale (sea) |
| snow | snail | farther (away) |
| wet | leak (water) | knee |
| wake | cheek | says |
| soft | brown | frighten |
| best | war (army) | until |
| met | toast | middle |
| cub | mitten | butter |
| fill | four (4) | male (man) |
| kind | spice | father (dad) |
| wag | without | afraid |
| bake | block | cause |
| miss | sheet | then (after that) |
| you (not me) | reach | coin |
| she | why | orange |
| bow (tie) | chair | sneeze |
| wave | town | heard (sound) |
| good | bowl | swear |
| save | dock | apple |
| kiss | pray (kneel) | goose |
| jump | face | biggest |
| bath | quick | crazy |
| frost | strange | people |
| pull | sent (mail) | happy |
| plus | ton | mother |
| stand | today | caught |
| loss | break (dish) | might (could) |
| hot | treat | address |
| hook | score | cent (coin) |
| tall | coach | heart |
| desk | pinch | heavy |
| stay | round | several |
| camp | hole (donut) | giant |
| flow | year | trouble |
| sing | maid (girl) | coming |

TABLE 2
LEVEL 2-3^{RD} & 4^{TH} GRADE

| | | MORE |
|---|---|---|
| EASIER | INTERMEDIATE | DIFFICULT |
| regular | disappoint | scenery |
| butter | basic | excellent |
| about | officer | anchor |
| tackle | anyone | whistle |
| roof | heaven | alien |
| computer | addition | celery |
| queen | written | carriage |
| label | subtraction | league |
| leaf | nervous | tomorrow |
| once | wreck | captain |
| season | slight | grieve |
| planet | doubt | government |
| become | people | delicious |
| while | comb | concern |
| window | comfort | awfully |
| waffle | quickly | practice |
| towel | occur | business |
| happen | special | tongue |
| student | brilliant | village |
| shower | famous | adjust |
| supper | beautiful | island |
| tonight | garage | guitar |
| bounce | quarrel | recipe |
| increase | achieve | sheriff |
| airport | palace | autumn |
| lose | although | doubtful |
| touch | across | distance |
| amaze | library | giraffe |
| cattle | supreme | cocoa |
| tardy | underwear | engine |
| miracle | police | balance |
| curse | convinced | therefore |
| relax | religion | squirrel |
| everyone | address | accident |
| protect | center | seizure |
| cabinet | paragraph | strength |
| barber | Saturday | muscle (arm) |
| prefer | grateful | pageant |
| bathroom | powerful | weighed |
| puzzle | smoking | certain |
| locket | gallon | emergency |
| handle | Tuesday | cupboard |
| mirror | carrot (food) | canoe |
| radio | meadow | buffalo |
| angle | elephant | sentence |
| camel | thankful | length |
| angel | ghost | headache |
| flower (plant) | cactus | veil |
| foggy | highway | definitely |
| tornado | vanilla | marvelous |
| popular | accept (allow) | equipment |
| mistake | tailor | straighten |
| figure | sensible | medicine |
| cable | peanut | allowance |
| whatever | confident | vacuum |
| ticket | central | belief |
| crooked | introduce | chimney |
| bucket | August | cinnamon |
| fault | actress | receive |
| nature | refrigerator | seize (take) |
| hamburger | typist | neighbor |
| shallow | several | scissors |
| history | dual (two) | glacier |
| fumble | tearful | typical |
| polite | mountain | toilet |
| shovel | neither | suggest |
| mustard | channel | spinach |
| minister | passenger | relief |
| exactly | correct | blonde |
| uncle | wonderful | baggage |
| pocket | acrobat | violence |
| travel | squeak | jewel |
| enjoy | continue | cruised |
| fiddle | cannon (gun) | rhythm |
| amount | vacant | laziness |
| tissue | process | voyage |
| yogurt | healthy | wrap (present) |
| daily | loosen | sugar |
| deposit | February | labeled |
| animal | paid | comma |
| arrow | cushion | auditorium |
| amuse | damage | certificate |
| south | urgent | physical |
| acorn | patient | experience |
| asleep | listen | hydrant |
| foul (not fair) | terrible | knowledge |
| memory | often | clothes (shirt) |
| turkey | fudge | exercise (use) |
| zipper | destroy | orchestra |
| middle | dumb | religious |
| stir | cocoon | stopped |
| weather (rain) | highlight | entrance |
| course (path) | unknown | beginner |
| oath | butcher | breathe |
| pillow | typhoon | yacht |
| glove | lovely | referee |
| monkey | thumb | bruised |
| contain | priest | taught |
| April | badge | burglar |
| pupil | soldier | dessert |
| easily | sewing | raccoon |
| bonus | colorful | banquet |
| perfume | wrist | restaurant |
| beneath | costume | diaper |
| human | curtain | forty |
| raisin | serpent | sunnier |
| gallop | shadow | weird |
| razor | squeeze | flour (bake) |
| speech | trouble | villain |
| desert | rodeo | vegetable |
| reason | Sunday | gnaw |
| square | Thursday | moisture |
| growth | disappear | bouquet |
| cotton | handsome | gnat |
| patio | imagine | cauliflower |
| dribble | humid | shepherd |
| example | inventor | skiing |
| fence | hurtful | iron |
| wealth | awhile | ogre |
| stingy | China | courage |
| prize | budge | wrestle |
| Friday | resemble | bargain |
| truly | vision | roommate |
| wagon | rescue | juice |
| dealt | justice | circuit |
| prepare | cyclone | excel |
| advise | poem | porpoise |
| teacher | onion | dinosaur |
| relative | circle | privilege |
| kingdom | tunnel | lying |
| dollar | violet | reindeer |
| complete | gentle | rhinoceros |
| above | traffic | routine |
| waitress | thief | gasoline |
| butterfly | laid | cabbage |
| serious | surround | dictionary |
| nicest | stretch | success |
| expect | value | faucet |
| picnic | notice | temperature |
| airplane | million | precious |
| public | plumber | beggar |
| deny | surface | decimal |
| yellow | kneel | audience |
| skier | knock | governor |
| envelope | knife | detour |
| worm | chef | chocolate |
| pajamas | promise | karate |
| tractor | terrific | knapsack |
| harvest | alright | broccoli |
| suppose | emperor | knight (armor) |
| motion | guess | groceries |
| author | military | century |
| scary | disguise | scheme |
| screen | toward | leopard |
| humor | hasten | sandwich |
| button | phase | capital (letter) |
| useful | pledge | ballet |
| liquid | lecture | machine |
| foolish | plastic | chisel |
| monster | impossible | quizzical |
| skeleton | goes | lunar |
| decay | Australia | coconut |
| populate | young | summary |
| chuckle | France | guilty |
| museum | niece | genius |
| theme | science | xylophone |
| bacon | eighth | laboratory |
| station | fuel | decent |
| crawl | whether (if) | disease |
| produce | twilight | cider |
| depth | laundry | favorite |
| universe | message | oyster |
| instead | except (not) | knot (rope) |
| sorrow | imagination | ocean |
| haze | average | macaroni |
| doctor | motor | troubling |
| dental | guard | unfortunate |
| opinion | decision | specify |
| blossom | interest | existence |
| horizon | bicycle | duel (fight) |
| chosen | limb | reference |
| tangle | bomb | gauge |
| dawn | treasure | handkerchief |
| cuff | among | fountain |
| choice | answer | chorus |
| poor | finally | debt |
| another | Indian | cello |
| wonder | recent | celebrate |
| power | freight | forehead |
| county | coward | absence |
| helmet | kitchen | budget |
| advice | pounce | weight (pound) |
| umbrella | charcoal | deceive |
| equal | victim | column |
| nearby | innocent | luggage |
| choose | pitcher | stomach |
| rumor | garbage | knuckle |
| usual | hospital | exhaust |
| pattern | problem | buses (school) |
| annual | opposite | fantasy |
| picture | yield | ostrich |
| aunt | balloon | chimpanzee |
| cookie | Monday | Chinese |
| backward | grief | creature |
| against | pursue | suite (room) |
| school | fantastic | separate |
| custard | mixture | welcome |
| thirsty | agency | nuisance |
| needle | excited | vein (blood) |
| English | idle (lazy) | gradually |
| family | mathematics | Wednesday |
| selfish | caught | dangerous |
| birthday | fought | ceiling (room) |
| visible | likely | pyramid |
| children | orange | caution |
| sailor | youthful | furnace |
| change | enough | pigeon |
| couch | heavy | naughty |
| arrange | important | tepee |
| until | double | describe |
| hungry | freeze | sorcerer |
| football | realize | sausage |
| enemy | safety | acquire |
| Canada | honest | different |
| dragon | alphabet | camera |
| collect | alligator | athlete |
| bottle | breakfast | schedule |
| grandfather | width | familiar |
| sparrow | ought | crochet |
| barrel | nickel | scientist |
| unless | thought | leisure |
| carpet | though | marriage |
| criminal | coarse (rough) | bologna |
| establish | gopher | measure |
| homework | guest | theater |
| single | fashion | argument |
| angry | service | boulevard |
| chicken | ounce | journey |
| borrow | speak | sleight |
| country | really | shoulder |
| dance | janitor | bracelet |
| donkey | catcher | calendar |
| perfect | sympathy | exhibit |
| follow | delicate | oxygen |
| finger | guide | feature |
| garden | design | ancient |
| frozen | actually | aisle (row) |
| glance | remarkable | fierce |
| artist | fortune | surprise |
| chance | crocodile | foreign |
| summer | dozen | galaxy |
| upstairs | busily | quarter |
| number | official | believe |
| should | purpose | whirled |
| slender | civil | beginning |
| forest | quart | apology |
| along | echo | guidance |
| spelling | pleasant | genuine |
| player | allergic | poison |
| strange | signed | ketchup |
| afternoon | judge | valuable |
| avenue | musician | sleigh (snow) |
| puddle | icicle | exhale |
| princess | question | coupon |
| member | similar | necessary |
| disgrace | discuss | dungeon |
| mental | height | congratulations |
| adverb | cough | whittle |
| adore | direction | thorough |
| movie | attempt | whisker |
| honey | errand | coffee |
| worst | capacity | language |
| dairy | hoarse (voice) | potato |
| article | weapon | challenge |
| pilot | boundary | tomato |
| multiply | college | prairie |
| rainbow | curious | absolutely |
| month | chief | develop |
| appear | toaster | patience (calm) |
| extra | nephew | possess |
| afraid | grudge | embarrass |
| bury | pilgrims | whisper |
| dangle | argue | anxious |
| vowel | feather | recognize |
| volume | fowl (bird) | happening |
| oldest | tennis | traveled |
| broom | sincere | shampoo |
| candle | awful | gigantic |
| visitor | eagle | surgeon |
| disaster | interrupt | portrait |
| erase | pleasure | route (road) |
| dozen | pretty | lizard |
| alert | flies | biscuit |
| noise | general | instance |
| hammer | majesty | principal (school) |
| taxi | predict | principle (rule) |
| north | private | lettuce |
| search | explorer | fulfill |
| triple | sought | saucer |
| fourth (4th) | sewer | mechanic |

TABLE 3
LEVEL 3-5^{TH} & 6^{TH} GRADE

| | | MORE |
|---|---|---|
| EASIER | INTERMEDIATE | DIFFICULT |
| praise | gesture | encore |
| wander | frequent | caterpillar |
| liberty | decent | cafeteria |
| harvest | salary | teammate |
| solution | digital | judgment |
| secure | wedge | contagious |
| boundary | disgrace | antique |
| common | lecture | generous |
| suppose | hymn (song) | desperate |
| motion | system | magnificent |
| harmony | magazine | generosity |
| sense (feel) | cease (stop) | circumstances |
| fiction | mixture | reign (rule) |
| panic | gradually | gymnasium |
| brief | decimal | negligee |
| champion | surround | cartridge |
| purse | receive | magician |
| luxury | preferred | crystallize |
| manager | citizen | innocent |
| inventor | lenient | laboratory |
| eagle | accurate | cellophane |
| fracture | conceal | architect |
| career | neutral | generally |
| expert | description | eventually |
| elephant | opportunity | conference |
| elevator | immortal | apparel |
| discussion | referral | banister |
| produce | typical | practicing |
| gentleman | continue | encyclopedia |
| copies | dictionary | environment |
| method | attorney | ignorance |
| service | building | daffodil |
| speech | language | aspirin |
| mammal | cedar | license |
| lamb | coupon | acceptable |
| summary | amusing | definitely |
| junior | ancient | doughnut |
| normal | bushel | forecast |
| beyond | journey | beige |
| patient | portrait | evidently |
| scarce | promise | overwhelm |
| pierce | exhale | buffet |
| companion | meager | embarrass |
| circulate | entrance | approximately |
| decoy | cement | specifically |
| steak (meat) | courage | counselor |
| creativity | responsible | labeled |
| captive | rescue | assistance |
| register | audience | accordion |
| battery | delicious | apostrophe |
| organize | syllable | luncheon |
| fertilize | parcel | occurring |
| radiant | rehearse | satisfactory |
| hammock | murmur | ridiculous |
| envious | pioneer | bookkeeper |
| major | cooperate | committee |
| disturb | shrivel | conscious |
| scramble | refrigerator | roommate |
| mission | cyclist | illiterate |
| contest | oxygen | coolly |
| vibrant | acreage | candidate |
| flexible | tardiness | insurance |
| outlet | margarine | exaggerate |
| bulletin | capacity | exhausted |
| significant | humorous | mustache |
| elegant | summarize | pageant |
| collector | marvelous | vicious |
| pillar | mysterious | cemetery |
| engage | plaid | necessary |
| abdomen | customer | importance |
| vary | scholar | existence |
| install | scheme | teachable |
| deposit | exhibit | professor |
| sensible | dreadful | pummel |
| convertible | privilege | Connecticut |
| divisible | apparent | musician |
| sociable | lavatory | nineteenth |
| available | orchid | omelet |
| reasonable | ambulance | overrated |
| agreeable | happiness | ghetto |
| favorable | monarchy | secrecy |
| breakable | probably | mischief |
| allowable | fashionable | salmon |
| tolerable | separate | character |
| safari | hiccup | therefore |
| satisfied | decision | colonel (army) |
| decided | recess | wheelbarrow |
| prepare | forty | Massachusetts |
| appear | mechanic | Mississippi |
| distance | orchard | mosquito |
| perhaps | prejudice | cologne |
| crease | ancestor | corduroy |
| native | pretzel | discipline |
| narrow | fossil | obedience |
| aroma | retrieve | Missouri |
| therapy | capitol (place) | Arkansas |
| idealistic | pier (dock) | alcoholic |
| equation | diamond | consensus |
| shuttle | measles | Illinois |
| entertain | emphasis | manila |
| steam | debris | conscience |
| televise | medicine | consequence |
| vacant | bungalow | gaseous |
| virtue | faithfully | procession |
| invisible | adequate | hygiene |
| article | excel | imbecile |
| coward | wring (twist) | opossum |
| loyalty | hydrant | campaign |
| region | scissors | shriek |
| chili (food) | appetite | asterisk |
| publish | inexpensive | heroes |
| quarrel | crouton | mileage |
| denied | reluctant | colossal |
| friction | mightily | traveler |
| quartet | sleight (of hand) | pavilion |
| directory | kindergarten | miniature |
| section | washable | cymbal (music) |
| opponent | advertisement | parallel |
| creator | speedometer | challenge |
| annual | biceps | pastime |
| splendid | fragile | monologue |
| repair | practical | pistachio |
| eager | sculptor | delicatessen |
| delight | volunteer | analyze |
| humble | clearance | thorough |
| afternoon | effective | neighborhood |
| bakery | kangaroo | drought |
| banker | argument | coliseum |
| border | appoint | bachelor |
| cable | awkward | upholstery |
| group | equipped | February |
| handle | feature | somersault |
| heart | fertile | loneliness |
| holy (sacred) | pollution | sergeant |
| increase | pronounce | lieutenant |
| industry | chemical | curiosity |
| exist | shoulder | overrule |
| property | circular | violence |
| protect | climber | symbol (mark) |
| provide | competition | physician |
| record | concern | accidentally |
| reduce | creature | debut |
| reply | definite | excitement |
| reward | exceed | Egypt |
| colony | dishonest | Europe |
| comfort | junction | tendency |
| comical | leather | guidance |
| condition | foreigner | parachute |
| confirm | meteor | analysis |
| constant | mayor | genuine |
| decay | referee | plague |
| define | significance | clique (friends) |
| dirty | banquet | holiness |
| discover | territory | nervous |
| hamburger | different | tomatoes |
| education | residence | harass |
| empty | valiant | vessel |
| invention | referred | cupboard |
| kindness | scenic | nauseous |
| mental | tragedy | glacier |
| level | wilderness | sacrifice |
| lumber | alter (change) | astronaut |
| melon | plantation | penguin |
| congress | altar (prayer) | forehead |
| graphic | casually | lightning |
| gossip | absence | gracious |
| musical | grateful | wintry |
| option | facial | souvenir |
| pardon | dormitory | fanciful |
| axle | versus | spaghetti |
| perfect | eligible | diesel |
| pickle | density | nuisance |
| speedy | financial | recommend |
| staff | fortress | grammar |
| pleasure | category | enormous |
| stroll | genius | performance |
| subject | missile | jealousy |
| supply | orphan | rehearsal |
| temper | political | fortunately |
| thread | poultry | sausage |
| blossom | macaroni | disguise |
| pocket | bridge | cinnamon |
| adopt | aluminum | echoes |
| adverb | algebra | especially |
| width | acquire | mattress |
| banjo | advantage | censor (book) |
| basin | calorie | hyphenated |
| blouse | chord (music) | misspell |
| display | spinach | literature |
| division | civilian | successful |
| duet | lettuce | doubtful |
| election | crystal | receipt |
| establish | delicate | sincerely |
| extra | society | headquarters |
| release | descent | tortoise |
| phrase | destination | courteous |
| resist | illustration | satellite |
| profit (money) | imaginary | journalist |
| prefer | instead | synonym |
| predict | introduce | democracy |
| positive | neighborly | magically |
| perish | manufacturer | solemnize |
| owner | sentence | grief |
| button | appliance | incredible |
| buyer | technical | fierce |
| cabinet | carefully | dominant |
| personal | pulley | earnest |
| contrary | tuxedo | technology |
| decade | vehicle | faucet |
| defeat | voluntary | recently |
| delivery | surprise | anonymous |
| crutch | cylinder | badminton |
| halo | dehydration | appearance |
| imitate | duplicate | authority |
| import | delinquent | forage |
| inquire | temperature | spacious |
| janitor | syrup | tournament |
| notify | ledge | barbecue |
| oblige | civilization | veterinarian |
| outfit | knowledge | lamppost |
| operation | proceed | eccentric |
| senator | brochure | guarantee |
| serious | commitment | instance |
| steady | opposite | attendance |
| solve | heritage | endurance |
| solo | excellent | specimen |
| writer | determine | associate |
| require | digestion | cancellation |
| unaware | employee | grievance |
| women | rhythm | condemned |
| zero | discriminate | paralyze |
| community | calendar | courtesy |
| critic | vagrant | turquoise |
| cuddle | vinegar | bluish |
| develop | warranty | emptiness |
| culprit | willful | beneficial |
| difficult | applaud | profession |
| disposal | knead (dough) | possession |
| durable | dough (bread) | marshmallow |
| eliminate | surgery | sapphire |
| infection | subdue | athletics |
| meant | captain | pursue |
| informal | believe | mischievous |
| injury | climate | conqueror |
| mascot | guardian | geyser |
| instrument | beginner | wholly (fully) |
| interior | facility | equivalent |
| strategy | lawyer | pronunciation |
| toward | geyser | picnicking |
| treatment | passenger | hysterical |
| massive | alibi | disastrous |
| manuscript | whisper | paralysis |
| lyric | certain | interesting |
| logical | island | gorgeous |
| library | cyclone | withdrawal |
| skeptical | coffee | peninsula |
| exclude | fusion | straight |
| recycle | finally | porridge |
| picture | politician | substance |
| relief | drainage | stubborn |
| curious | oyster | suspicious |
| terrible | restaurant | dissatisfied |
| segment | beverage | collapsible |
| substitute | allowance | molasses |
| portable | guitar | sauerkraut |
| tension | sphinx | potatoes |
| truthful | leisure | etiquette |
| triumph | congratulate | stationary (fixed) |
| trophy | salvage | stationery (paper) |
| preview | trapeze | zucchini |
| ambition | popular | allegiance |
| telephone | cauliflower | bureau |
| exactly | vague | newsstand |
| ecology | vicinity | questionnaire |
| assistant | vegetable | extraordinary |
| dramatic | handkerchief | catastrophe |
| geometry | choir | amateur |
| annoy | python | quiche |
| dismiss | jewelry | avalanche |
| several | geography | mayonnaise |
| attic | heifer | technique |
| reality | poisonous | chlorine |
| trumpet | patience (calm) | continually |
| ruined | frontier | successor |
| carriage | cellar (basement) | independent |
| gospel | ordinary | collision |
| pollen | peaceful | secretary |
| galaxy | agency | fascinate |
| telescope | currency | conceited |
| population | exercise | disciple |
| commit | experience | appreciate |
| attention | unique | assignment |
| arithmetic | proctor | acknowledge |
| automobile | design | criticize |
| consistent | figurine | wholesome |
| improper | blessed | ventriloquist |
| ingredient | boulevard | essential |
| exchange | engineer | symmetrical |
| approach | explanation | ecstasy |
| densely | valuable | accumulate |

TABLE 4
LEVEL 4-7^{TH} & 8^{th} GRADE

| | | MOST |
|---|---|---|
| EASIER | INTERMEDIATE | DIFFICULT |
| abrupt | celebration | conscience |
| angle | complexion | pharmaceutical |
| instructor | physical | psychiatrist |
| tremendous | suppress | abhorrent |
| employer | courteous | dyslexic |
| plea | aerial | pseudonym |
| malice | elementary | hierarchy |
| breathe | significance | sovereignty |
| cinder | neutron | mortgage |
| container | capillary | forfeiture |
| passenger | basically | withheld |
| marriage | debtor | aggravate |
| example | chronicles | rapacious |
| enemy | beggar | buoyed |
| handsome | malign | mischievous |
| government | judicious | antecedent |
| envelope | belligerent | accessory |
| equator | feasible | pantomime |
| tying | guarantee | blasphemy |
| remember | capsule | desperate |
| journalist | martyr | boisterous |
| distance | justification | clientele |
| merchandise | simplicity | innumerable |
| sporadic | medicinal | atrocious |
| ballot | ignorance | counterfeit |
| chapter | consign | boycott |
| scenery | accumulate | despondent |
| fabric | chaos | fluorescent |
| century | challenge | carburetor |
| skies | shampoo | antonym |
| squirrel | knapsack | irresistible |
| creature | sequence | chlorine |
| attractive | congratulate | intercede |
| toxic | gracious | humorous |
| clause (words) | petroleum | tsunami |
| drawer (desk) | siege | diffidence |
| glossary | succumb | sojourn |
| shadow | shepherd | choreography |
| dignity | sentence | occurred |
| equation | counselor | collectible |
| experience | suede | ascension |
| museum | column | sacrilegious |
| irony | antidote | catalogue |
| igloo | independent | scrimmage |
| circular | compromise | allegiance |
| married | cuisine | mistletoe |
| operator | enormous | crystallize |
| commander | cliche | rhythmic |
| budget | fascinate | synagogue |
| mechanic | wheelbarrow | committed |
| meanwhile | associate | conscientious |
| graduate | glamour | extraordinary |
| index | audience | genealogy |
| Pacific | acceptance | anesthetic |
| despair | concurred | statistician |
| pupil | especially | pilgrimage |
| odor | mysterious | acquaintance |
| exhibit | concern | foreseeable |
| offense | controversy | exaggerate |
| resemble | tariff | ensemble |
| fourteen | homogenize | pavilion |
| abundant | artificial | discretionary |
| contradict | fiery | picturesque |
| optimism | professor | vaccinate |
| opponent | interpretation | auxiliary |
| persist | mention | incidentally |
| puddle | hospitable | propaganda |
| perspire | meticulous | perceptible |
| indulge | impregnable | inconsolable |
| parish | treacherous | erosion |
| prognosis | amphibian | crouton |
| camera | emphasis | grievous |
| figurative | vicinity | grotesque |
| digestion | license | necessitate |
| collapse | concise | grandeur |
| scientist | luncheon | diligence |
| fantasy | enhance | jeopardize |
| tourist | tendency | questionnaire |
| delegate | pronunciation | devastate |
| canyon | efficient | personnel |
| disposal | accomplish | cartilage |
| individual | psalm | prerogative |
| forbidden | havoc | controversial |
| insinuate | relevant | sincerely |
| factual | commission | veterinary |
| lovely | seminary | reversible |
| source | simile | dissatisfied |
| lying | usage | stubbornness |
| recline | fanciful | particularly |
| quantity | enigmatic | colleague |
| safety | frequency | threshold |
| biography | athletic | prestigious |
| portray | pessimism | propagate |
| visible | synonym | discrepancy |
| density | sandwich | memento |
| vacant | courageous | adjoining |
| apartment | reticent | aerobics |
| applaud | luxurious | anonymous |
| automobile | adjacent | cinnamon |
| memorize | caterpillar | accommodate |
| eon | dictionary | accelerate |
| ingredient | volcanoes | intrigue |
| distribute | leisure | genre |
| authority | convertible | metaphor |
| magnetic | cigarette | parliament |
| scheme | overwhelm | commemorate |
| continent | absence | cantaloupe |
| dangerous | separate | interrogate |
| violet | triumphant | ukulele |
| dramatic | financial | synchronize |
| cafe | acknowledge | massacre |
| advantage | larceny | chauffeur |
| pasture | plague | zoology |
| accurate | illicit | alumnae |
| politics | defiant | appellate |
| orchard | karat (jewel) | defendant |
| electricity | discipline | upholsterer |
| adjust | innocent | hindrance |
| recede | ferocious | moccasin |
| motive | laboratory | deterrence |
| violent | conjure | remembrance |
| advice | achievement | physique |
| niece | amphibious | extravagant |
| thousand | plaque | exceed |
| engineer | peninsula | proceed |
| system | prophecy | schism |
| eminent | quarantine | millennium |
| imminent | commercial | liaison |
| extension | consequence | entrepreneur |
| throughout | intricate | opulence |
| conceal | condemn | omitted |
| economy | labeled | plaintiff |
| myth | emptiness | accompaniment |
| replacement | accidentally | practically |
| geography | testimonial | Hawaii |
| terrible | algae | feigned |
| impossible | mileage | behoove |
| curious | currency | parenthesis |
| ministry | plentiful | rhetoric |
| obey | crochet | diurnal |
| triangle | spontaneous | diaphragm |
| purchase | excellent | nowadays |
| injury | facility | corollary |
| poetry | foreword (book) | sergeant |
| insecure | docile | malefactor |
| silence | dialogue | bookkeeper |
| skillful | croquet | playwright |
| contribute | misspell | criticism |
| illegal | phantom | permanently |
| violence | myriad | reminiscent |
| usually | juvenile | abundance |
| grocery | nuisance | dietitian |
| familiar | illogical | catechism |
| flexible | courtesy | susceptible |
| insinuate | ancestry | subtlety |
| comfortable | analysis | kilowatt |
| complain | altogether | licorice |
| legend | fiendish | reservoir |
| dubious | memoir | impromptu |
| recent | colonel (army) | wondrous |
| ledge | comprehension | heinous |
| feature | scenario | adolescent |
| opposite | coliseum | nonchalant |
| storage | delicious | pitiful |
| kernel (corn) | debris | savvy |
| garment | cupboard | apparently |
| describe | clemency | controlled |
| fastidious | flourish | correlate |
| rehearse | conceited | disastrous |
| dwelling | medicine | monotonous |
| evening | pamphlet | vengeance |
| counter | fiercely | disappearance |
| recycle | compassionate | emphysema |
| follow | performance | medieval |
| complex | buffet | anoint |
| carriage | inaugural | grievance |
| mixture | obnoxious | righteous |
| suggestion | propel | indisputable |
| Atlantic | plethora | recommend |
| radiant | accustom | hypothetical |
| contest | reconcile | delectable |
| social | officious | facetious |
| exchange | intolerant | turbulence |
| conquer | prairie | inoculate |
| ragged | curiosity | medallion |
| heroes | dilapidated | fatigue |
| typical | gourmet | larynx |
| massive | successful | vertebrate |
| epitomize | distraught | anomaly |
| ignorant | vintage | descendant |
| destroy | marshmallow | plenitude |
| whine (moan) | cologne | compelling |
| periodic | irrelevant | renowned |
| hatchet | contemporary | homonym |
| honorable | laughable | themselves |
| icicle | coordinate | frolicking |
| depot | ghastly | perseverance |
| mayhem | coordinate | serrated |
| officer | necessary | prescription |
| exercise (work) | propensity | euphemism |
| coupon | paralyze | archaeologist |
| discriminate | parachute | inconceivable |
| description | wistful | caffeine |
| vigilante | maintenance | annihilate |
| humble | naive | pastime |
| obscure | gruesome | critique |
| intelligence | gnawing | supersede |
| agile | nauseous | besieged |
| frequent | radiance | lieutenant |
| sensory | customary | outrageous |
| facial | accomplice | accordion |
| combination | embarrass | guttural |
| probably | chauvinism | quizzes |
| misery | marmalade | mathematics |
| secretly | classification | macabre |
| organize | valor | assassin |
| adventure | missile | serviceable |
| specific | parallel | mediocre |
| element | niche | dilemma |
| obstacle | kerosene | roughhouse |
| paragraph | continuous | prevalent |
| legible | metallic | rapport |
| washable | catapult | canvas (cloth) |
| culture | sauerkraut | autonomous |
| various | novice | apocalypse |
| tactical | bachelor | acoustics |
| awkward | granite | laughable |
| saturate | hosiery | oppression |
| finalize | expedite | adjournment |
| advance | appropriate | chaperon |
| practical | scissors | quandary |
| incentive | scholastic | noticeable |
| condition | traveler | ecstasy |
| hardship | conceive | tomorrow |
| constant | eccentric | advantageous |
| mingle | merciful | precipice |
| connection | heritage | endeavor |
| extract | explicit | catastrophe |
| rumor | pheasant | aerosol |
| fertilize | primitive | hesitancy |
| thunder | hideous | legitimate |
| historic | valet | camouflage |
| customer | preferable | narcissistic |
| mobilize | regime | predecessor |
| humidity | mammoth | hypothesis |
| evident | pursue | minuscule |
| graphic | overrated | ghettoes |
| technology | receipt | colossal |
| raisin | abysmal | reference |
| policy | attendant | graffiti |
| descent | llama | intercession |
| equipment | amnesty | characterize |
| tangible | prominent | succession |
| tailor | dominant | sophomore |
| material | sufficient | inadvertent |
| neutral | turquoise | tourniquet |
| chief | secede | indispensable |
| category | asthma | Caribbean |
| shutter | nucleus | flabbergasted |
| shuffle | sedentary | occasionally |
| salvation | wholly (fully) | collateral |
| recluse | procedure | bouillon |
| visitor | misfortune | irrefutable |
| nickel | genuine | evanescent |
| pronounce | strenuous | raucous |
| tornado | interrupt | protocol |
| altercation | amorous | maneuver |
| distress | exceptional | miscellaneous |
| divine | culinary | discernible |
| domestic | malicious | preference |
| easier | correspondence | loneliness |
| eject | acclaim | resemblance |
| eligible | oblique | poignant |
| exotic | advertisement | overrun |
| existence | obstinate | chauffeur |
| expression | newsstand | incandescent |
| meteor | anecdote | realistically |
| exhale | mosque | unforgettable |
| mystery | synopsis | mannequin |
| nylon | asterisk | idiosyncrasy |
| obesity | elicit | facsimile |
| obsolete | berserk | omission |
| feud | precipitation | exorbitant |
| mesmerize | mayonnaise | pummel |
| shovel | cancellation | exuberance |
| erroneous | capricious | plagiarize |
| eliminate | plateau | fundamentally |
| assignment | legitimize | aeronautical |
| bulletin | compel | harassment |
| cashier | consensus | camaraderie |
| classic | referred | thoroughbred |
| college | paucity | irresponsible |
| comedy | fortunately | pasteurize |
| federal | franchise | renege |
| faulty | miniature | masquerade |
| further | gymnasium | silhouette |
| galaxy | decipher | croissant |
| inept | passable | imbecile |
| semester | solitary | chrysanthemum |
| explanation | diorama | manageable |

TABLE 5
LEVEL 5 - ADULT

| | | MORE |
|---|---|---|
| EASIER | INTERMEDIATE | DIFFICULT |
| tobacco | overwrought | shillelagh |
| encore | cockroach | anesthetize |
| antenna | cache (hidden) | dilettante |
| phenomenon | bucolic | pleurisy |
| gauze | croissant | Polyethylene |
| pungent | camisole | demitasse |
| juxtapose | ecumenical | demagoguery |
| precipitous | apothecary | manageable |
| inauguration | abysmal | reveille |
| ridiculous | bailiff | maraschino |
| systematic | nourishment | corpuscle |
| protein | melancholy | bellwether |
| complexion | gossamer | resalable |
| plateau | concierge | androgynous |
| rigorous | ensign | serendipitous |
| pessimistic | tableau | quintessence |
| emphasis | sojourn | reconnaissance |
| observatory | poignant | graffiti |
| relevant | synchronize | cognoscenti |
| chiropractic | calisthenics | psoriasis |
| primitive | incessant | paraplegic |
| foliage | ingenious | pachysandra |
| excellent | necessary | fluorescent |
| resilient | turquoise | phosphorescent |
| chiropodist | picturesque | perspicacity |
| aerosol | negligee | colossal |
| conceited | choreography | traveler |
| courteous | encumbrance | bourgeoisie |
| collaborate | libelous | disastrous |
| apparent | rhinoceros | raspberry |
| gorgeous | treacherous | coliseum |
| orthodox | macabre | inadmissible |
| hemisphere | upholstery | nonpareil |
| asylum | augur | baccalaureate |
| cachet | submersible | vicissitudes |
| tyranny | massacre | sequoia |
| disposable | impugn | rhododendron |
| itinerary | overreact | inane |
| phoenix | rescission | sarsaparilla |
| novice | mediocre | cacophony |
| inure | campaign | dilapidated |
| ferocious | centripetal | rendezvous |
| seclusion | discernible | subpoena |
| paucity | antecedent | rapprochement |
| eulogize | tutelage | yarmulke |
| adolescent | hyperbole | semblance |
| homicide | pneumatic | chauffeur |
| nuisance | visceral | motif |
| extenuating | lecherous | pasteurized |
| superficial | ensemble | prerogative |
| javelin | disheveled | quandary |
| memoir | humongous | vengeance |
| volatile | vehement | chamomile |
| priority | statistician | embryos |
| paradise | moniker | onomatopoeia |
| library | placebos | somersault |
| receive | linguine | clientele |
| secretary | nomenclature | commemorate |
| unnatural | guillotine | archipelago |
| elicit | indictment | parakeet |
| murmur | dependable | tourniquet |
| circumstances | loquacious | monstrosity |
| indicative | accessible | pseudonym |
| conclusion | immovable | expendable |
| sagacious | noticeable | liaison |
| paralyze | prescient | curiosity |
| contagious | behemoth | iridescent |
| cartilage | gauche | ecstasy |
| excitable | inflammable | nauseous |
| pamphlet | rheumatism | occurrence |
| demur | milieu | hors d'oeuvre |
| gorilla (ape) | incalculable | mnemonic |
| pinnacle | horrific | mischievous |
| magnanimous | soiree | lackadaisical |
| gourmet | consolation | xenophobia |
| valuable | pernicious | psychoanalyst |
| heirloom | unnecessary | pastime |
| obsequious | grandeur | shenanigans |
| accomplice | flagellate | paleontology |
| indicia | misogyny | propaganda |
| hyphenate | boudoir | irrefutable |
| delinquency | chandelier | a cappella |
| dinghy | threshold | pirouette |
| jettison | coercion | dispensable |
| ironic | pheromone | phantasmagoric |
| recalcitrant | pastiche | unparalleled |
| slaughter | maneuver | schizophrenia |
| savant | sashay (walk) | malleable |
| exhort | scintilla | mannequin |
| audience | cancellation | camouflage |
| Braille | livelihood | annihilate |
| interrupt | souvenir | pharmaceutical |
| niche | plentiful | effete |
| certitude | pneumonia | cetacean |
| philosophy | colonel | debutante |
| inconsolable | labyrinth | pterodactyl |
| catharsis | cistern | chartreuse |
| degenerate | ricochet | quadriplegic |
| gnawing | aneurysm | pavilion |
| maintenance | chagrined | saccharine |
| reference | devastate | renaissance |
| supervised | prurient | meringue |
| derelict | quixotic | echinacea |
| deceit | recognizance | desiccate |
| controversial | menagerie | carburetor |
| hospitable | burlesque | camaraderie |
| potential | altogether | bayonet |
| decedent | surveillance | bivouac |
| subtle | serviceable | panache |
| conservative | inimitable | mellifluous |
| petroleum | miscellaneous | incandescent |
| contemporary | broccoli | lieutenant |
| visage | pariah | ptomaine |
| syndicate | apocalypse | whippoorwill |
| gymnastics | codeine | sauerbraten |
| consecrate | ubiquitous | propagate |
| innocent | holistic | connoisseur |
| optimal | preponderance | convalescence |
| advocate | paparazzi | exorbitant |
| domicile | truculent | idiosyncrasy |
| fallacy | torturous | fettuccine |
| telepathy | physicist | formaldehyde |
| pulchritude | sepulcher | obeisance |
| masculine | memento | dossier |
| auxiliary | dysfunctional | peaceable |
| perceptive | grotesque | resuscitate |
| parenthesis | capricious | imprimatur |
| voracious | innuendo | monsignor |
| physician | synonymous | daiquiri |
| chimerical | perquisite | cirrhosis |
| erroneous | paradigm | drunkenness |
| intelligible | stalactite | eczema |
| cryptic | uproarious | smorgasbord |
| practicable | ignoble | hallucinogenic |
| procedural | dilemma | piranha |
| treatise | elementary | beaucoup |
| commodity | zephyr | impresario |
| transferred | travelogue | decaffeinated |
| device | coolly | arbitrageur |
| correspondence | bachelor | saboteur |
| excess | abhorrent | beleaguer |
| auspices | irreducible | filibuster |
| edifice | forego | indefatigable |
| exquisite | indelible | machete |
| transient | reproach | bureaucrat |
| sandal | hygiene | colloquial |
| simultaneous | masquerade | scurrilous |
| pursue | guerilla (war) | sacrilegious |
| exhilarate | zeppelin | apocryphal |
| wistful | pageantry | querulous |
| subliminal | protocol | pharaoh |
| locale | adieu | peignoir |
| enclave | fulfill | rhetorical |
| glutton | impasse | Chihuahua |
| polygamy | canister | chameleon |
| whimsical | collectible | withhold |
| quiche | masseur | detente |
| appropriate | erosion | hemorrhage |
| medicinal | epithet | prenuptial |
| aluminum | requisite | diligent |
| beneficiary | omitted | fusillade |
| vague | forfeiture | annulment |
| anticipate | incorrigible | occasionally |
| tremendous | cologne | avoirdupois |
| electrician | anemone | expungeable |
| forego | brogue | suborn |
| relegate | recommend | internecine |
| hosiery | licorice | meiosis |
| parlance | committee | oscillate |
| earring | incidentally | colloquy |
| respite | sustenance | embarrassed |
| concentrate | harangue | archaeology |
| misfit | solicitous | continuum |
| notoriety | pittance | wherewithal |
| allegiance | susceptible | dietitian |
| pecuniary | exaggerate | ukulele |
| syntax | accordion | dyslexic |
| composite | subterranean | millennium |
| syllabus | comedienne | infinitesimal |
| eclectic | stalagmite | fuchsia |
| glamorous | toupee | mezzanine |
| fissure | catatonic | colloquially |
| amnesty | curvaceous | Fahrenheit |
| deficient | infallible | aneurism |
| psyche | reminisce | hypocrisy |
| definite | synthesize | asinine |
| eccentric | caterpillar | fuselage |
| scalpel | irrepressible | septuagenarian |
| avarice | corrosion | apropos |
| ostrich | unprecedented | inchoate |
| opaque | televangelist | masseuse |
| surveyor | roulette | tyrannosaurus |
| giraffe | overwhelm | nouveau riche |
| kerosene | rutabaga | fricassee |
| criticize | mortgage | pirogi |
| haphazard | mimicry | psychosomatic |
| debilitate | matinee | plenteous |
| gigolo | octogenarian | boutonniere |
| cursory | presumptuous | bouillabaisse |
| separate | successful | ayatollah |
| menace | anomalous | repertoire |
| celestial | epitaph | potpourri |
| novitiate | enthusiastically | anathematize |
| governor | curmudgeon | phlegmatic |
| prevalent | pomegranate | faux pas |
| appetite | leprosy | implacable |
| grimace | forsythia | retaliate |
| misgivings | expel | pantomime |
| echelon | blasphemy | therapeutic |
| distance | hierarchy | syllogism |
| gelatin | circuitous | tonsillectomy |
| tragic | chateau | toreador |
| accessory | ostensible | anoint |
| havoc | harass | eponymous |
| turbulence | imbroglio | sassafras |
| austerity | bassinet | antediluvian |
| analysis | lasagna | sophomoric |
| climatic | promenade | changeable |
| imitate | fortuitous | quiescent |
| ceremony | wondrous | chutzpah |
| suspicious | resilience | inoculate |
| incisor | extravagant | denouement |
| dissect | fallacious | dumbbell |
| equipment | handkerchief | soporific |
| spinach | furlough | philodendron |
| hysterical | parmesan | hypochondriac |
| receivable | quizzical | hallelujah |
| counterfeit | pilgrimage | diphtheria |
| preferred | malfeasance | euphemism |
| specimen | climactic | corollary |
| palpable | incendiary | avant-garde |
| atheist | voyeurism | cummerbund |
| preemptive | anachronistic | peccadillo |
| publicly | override | leprechaun |
| apprentice | octahedron | poinsettia |
| infancy | transcendental | proselytize |
| terse | personnel | headdress |
| legislature | sycophant | discotheque |
| eloquent | vignette | psychedelic |
| consensus | declension | philatelist |
| homage | facsimile | symmetrical |
| dimension | quarantine | consanguineous |
| feminine | unnerve | queue (line-up) |
| courier | scythe | addressable |
| dialogue | precipice | hieroglyphics |
| parliament | oxymoron | entrepreneur |
| lavender | hubbub | savoir faire |
| insinuate | camellia | deterrence |
| precious | decrepit | orangutan |
| conjecture | liquefy | zucchini |
| gigabyte | plaintiff | genealogy |
| peninsula | odoriferous | pusillanimous |
| beguile | dichotomy | brassiere |
| prophecy | souffle | collateral |
| satellite | kleptomaniac | rotisserie |
| deceive | hypocrite | bouffant |
| centigrade | penicillin | diaphragm |
| versatile | reticent | tarpaulin |
| facade | lyceum | pyrrhic |
| myriad | champagne | amethyst |
| assent (agree) | fracas | vacillate |
| heinous | vacuous | proboscis |
| decibel | innocuous | irascible |
| conspicuous | coefficient | crustacean |
| exuberant | kaleidoscope | silhouette |
| disgraceful | gladiolus | minuscule |
| syringe | synopsis | pachyderm |
| conjure | accommodate | crystallize |
| despair | derriere | soliloquy |
| emancipate | defendant | paraphernalia |
| tentacle | businessman | mademoiselle |
| virulent | stoically | staphylococcus |
| feign | intransigence | luminescence |
| millionaire | lozenge | aficionado |
| caricature | ephemeral | supercilious |
| anecdote | mousse (hair) | protege |
| cronyism | imbecile | reconnoiter |
| spontaneous | putrefy | odyssey |
| supremacy | turmeric | clairvoyance |
| ambitious | omniscient | chlorophyll |
| rampage | physique | ingenue |
| diorama | collision | picayune |
| receipt | chronicles | chastise |
| exhaust | desecrate | debonair |
| obstinate | facetious | stubbornness |
| grateful | chassis | dachshund |
| platypus | analogous | cappuccino |
| grammar | dispel | encephalitis |
| desolate | phenomenal | insouciant |
| nutrient | illegitimate | fait accompli |
| lightning | forbearance | buoyant |
| ambiguous | cataclysm | cuneiform |
| ignorance | garrulous | remittance |
| franchise | maelstrom | archaeopteryx |
| flourish | perseverance | paean |
| archaic | syncopated | vinaigrette |
| prowess | vaudevillian | bouillon |
| ballistics | flabbergasted | kielbasa |
| conversant | aesthetic | cater cornered |
| absence | desperate | flotation |

The spelling difficulty of the words in each game level is determined by various criteria. Initially, as noted above, the spelling words for each game level are obtained from known age and educational grade level spelling lists. In order to minimize inconsistencies in determining the appropriate grade level and/or difficulty of any given spelling word(s), words taken from known spelling lists are preferably from the same source.

Other criteria useful for determining the difficulties of the spelling words include the word length in letters, number of syllables, the number of silent letters, the number of double letters, how often the average player at a given game level would typically read, write, hear or speak the word in the course of the player's studies, recreational activities and/or normal daily interactions, the number of possible spellings caused by sounds that can be spelled by at least two different letters or combinations of letters following the “non-phonetic rules” described below, the number of homonyms, the degree to which the same sound/letter combinations are contained in other words in the same age or educational grade level of the game or in a lower age or lower educational grade level of the game. One or more of these criteria can be used to distinguish between levels of difficulty for words within a game level.

Generally, spelling words that are in the EASIER spelling difficulty category are common, everyday words that are spelled exactly as they sound. By “common every day words” is meant words that the average age or educational grade appropriate player would be expected to read, write, hear or speak in the normal course of the player's studies, recreational activities and/or normal daily interactions. The words in the EASIER category of any game level will also generally be shorter in number of letters and of the lowest relative vocabulary difficulty of the words included in that game level.

For the purposes of this invention, the following are considered to be among the most basic and common non-phonetic letter/sound patterns in the English language and are referred to herein as the “non-phonetic rules”: 1) The addition of the letter “e” at the end of a word will generally create a long vowel sound in the preceding vowel; 2) A long “e” sound at the end of a word is generally formed by the letter “y”; 3) A “k” sound at the end of a word is usually formed by the letters “ck”; 4) A “k” sound at the beginning of a word is usually a hard “c” rather than a “k”; 5) The vowel sound in words rhyming with the word “book” is formed by the letters “oo”; 6) The vowel sound in words rhyming with the word “cool” is generally formed by the letters “oo”; 7) The sound “owt” is formed by the letters “out”; 8) The sound “kw” is formed by the letters “qu”; 9) The sound “shon” is formed either by the letters “tion” or “sion”; 10) The sound “yon” is usually formed by the letters “ion”. For the purpose of determining the spelling difficulty category of a particular word, it is presumed that the player(s) has knowledge of phonics as well as knowledge of the non-phonetic rules. Therefore the occurrence of the non-phonetic letter/sound patterns in any word will not affect the spelling difficulty category of the word except in game levels one and two where full knowledge of phonics and the non-phonetic rules is not presumed. In game levels one and two, words may be categorized in other than the EASIER category, on the presumption that the rules of phonics and the non-phonetic rules are still being learned by the player. The term “phonics” is used herein to indicate knowledge of symbols, e.g. one or more letters, that represent only one speech sound.

Sound/letter patterns and possible spellings and/or questionable spelling sounds which are included in words in the MORE DIFFICULT category of a lower level of the game, can be used in the INTERMEDIATE category of the next highest game level and possibly in the EASIER category of the game levels higher than that.

Since the words in the EASIER category are spelled, for the most part, exactly as they sound, or can be spelled correctly by a player with knowledge of the most basic and common letter/sound patterns of the language of the word to be spelled_and because of the words' shorter length in number of letters, the anticipated higher degree of familiarity with the words, it is anticipated that a player's probability of correctly guessing the spelling of a word that the player is unfamiliar with in the EASIER category of any game level will be greater than 75%.

As a general rule, the vocabulary level for the INTERMEDIATE spelling words will be higher than that of the EASIER words and the vocabulary level for the MORE DIFFICULT spelling words will be higher than that of the INTERMEDIATE words.

Most of the words in the INTERMEDIATE category words will suggest one alternate spelling, i.e. one correct spelling and one improper spelling for a player who has knowledge of phonics and the “non-phonetic rules” and utilizes that knowledge. As used herein, “alternate spelling” indicates that a word has more than one spelling, albeit incorrect, as a result of a sound which may be spelled by at least two different letters or at least two different combinations. Examples of words that have alternate spellings include heat or heet, girl or gurl, and coat or cote. Words having alternate spellings also include words that have two different spellings and have different meanings dependent on their spelling, such as heal and heel, and too and two, (i.e. homonyms). INTERMEDIATE spelling difficulty words may also include words with one alternate spelling by reason of a word having an “alternate spelling sound” caused by a silent letter or a double letter. As used herein, “alternate spelling sound” is a sound that can be formed by either of two different letters or by at least two different combinations of letters. Words containing alternate spelling sounds also include words that have silent letters or double letters.

Since the INTERMEDIATE category words are chosen, for the most part, to suggest only one alternate spelling, a player having knowledge of phonics and non-phonetic rules and utilizes that knowledge, it is anticipated that a player's probability of correctly guessing the spelling of a word that the player is unfamiliar with in the INTERMEDIATE category of any game level will be about 50%.

All of the words in the MORE DIFFICULT will suggest at least one improper spelling to the average age or educational grade appropriate player, and many of the words in the MORE DIFFICULT category will suggest two or more improper spellings to such a player.

The words categorized in each game level as MORE DIFFICULT are also often identified as “spelling demon” words. As used herein, the term “spelling demon” means words identified as such and words on lists contained on the world wide web or in printed lists or published books of spelling words or words that appear in compilations of the most often misspelled words or in compilations of most difficult spelling words that are contained on the world wide web or in printed lists or published books of spelling words.

Examples of spelling demon lists found on the world wide web including websites such as:
http://www.infoplease.com/cig/grammar-style/spelling-demons.html.
http://classroom.jc-schools.net/read/spelldemons.htm
http://www.ccs.k12.in.us/cte/Classroom/5th%20Grade/Mahnesmith/Curriculum/Spelling
http://www.esldesk.com/esl-quizzes/misspelled-words/misspelled-words.htm
http://www.wsu.edu/˜briands/errors/misspelled.html
http://www.yourdictionary.com/library/150more.html and
http://www.brnsdle.demon.co.uk/spell/error.html. These sites are provided as examples.

Words categorized as MORE DIFFICULT within a particular game level will generally be words that the average age or educational appropriate player will be the least familiar with. In other words, words within a particular game level that the average player at a given game level will have the least occasion to use, read, speak and/or hear in the course of that player's studies, recreational activities and/or normal daily interactions.

As a result of the combination of multiple alternate spellings, alternate spelling sounds, the higher relative vocabulary level of the word, and because of the frequent inclusion of known “spelling demons” words in the MORE DIFFICULT category of the game, it is anticipated that a player's probability of correctly guessing the spelling of a word that the player is unfamiliar with in the MORE DIFFICULT category of any game level will be less than 25%.

Some of the words on the spelling cards, regardless of game level, will have homonyms. A homonym is a word that is identical in pronunciation to other words but differing in meaning, e.g. hair and hare. If a spelling word has a homonym, a word in parenthesis is written next to the spelling word which the reader uses to distinguish which word should be spelled. For example, if the spelling word is “hair” the word “head” may appear in parenthesis next to it and the reader should say “hair, as in hair on your head”, or make a similar statement when reading the word to the speller.

The illustrated embodiment also comprises playing cards which are used to add excitement and competition to the game. The playing cards include “BUZZLEBEE” cards that a player draws during play. Each of these “BUZZLEBEE” cards has instructions which direct a player's movement of his playing piece. These instructions are sometimes beneficial; however, they can also be detrimental. A playing card, which is identified as a “BUZZLEBEE Card” in the preferred embodiment of the game, is drawn when a player lands on one of the “Bee” spaces on the game board. Use of the playing cards and the instructions printed on the playing cards is described more fully below.

The random determining means preferably comprises one die which preferably comprises six sides with indicia corresponding to different levels of spelling difficulty. During play, a die is rolled by a player to determine the spelling difficulty of the spelling word to be spelled by that player. Alternatively, the determining means may include a spinner or other such device. The indicia on the die or other determining means comprises one or more different colors, shapes, numbers, other indicia, or a combination of different indicia.

This illustrated embodiment uses three different colors, to identify three different levels of spelling difficulty of words on each spelling card. For example, a die using color as an indicia to differentiate the different spelling difficulties has 2 opposite yellow sides, 2 opposite_green sides and 2 opposite blue sides. The yellow indicia identifies words of an EASIER spelling difficulty level, the green indicia identifies words of an INTERMEDIATE spelling difficulty level, and the blue indicia identifies words of a MORE DIFFICULT spelling difficulty level.

The following is a description of the method of play of the illustrated embodiment. Play begins by each player selecting one of the playing pieces to move along the game board. The players then place their playing pieces on a START space 11 identified on the board by an indicia at the lower left hand corner of the game board. About one hundred spelling cards are randomly selected from the three hundred spelling cards 30 provided for each game level. If all players are in Level 1 of the game, then only spelling cards from that game level will be used. However, if there are players of different game levels playing, about one hundred spelling cards from each of those different game levels will be randomly selected so that each player is challenged with spelling words of the appropriate game level. After the spelling cards are selected, each deck of selected spelling cards is placed with the spelling word side down and the appropriate stack is moved as play progresses so that it is within the reach of the next reader or a designated reader of the spelling word.

A designated person can be chosen who only reads the words and does not take part in spelling any words, i.e. a “designated reader”. Alternatively, if there is not a designated reader, the player to the right of the player rolling the die, i.e., the speller, will be the “reader” for that turn. A player begins his turn by rolling the die to determine the difficulty level of his spelling word. The reader selects a spelling card by drawing the first card from the appropriate deck of spelling words according to the speller's game level and the reader reads the word on the selected spelling card corresponding to the difficulty level determined by the indicia on the die rolled by the speller. If the player requests the word's definition and/or derivation, the reader will also read the definition and/or derivation for the speller from a dictionary. The speller will, optionally, write his spelling word on a piece of paper, to facilitate his decision on a final spelling. The speller then reads his final spelling of the selected spelling word aloud. If the speller's printed spelling is correct but he mistakenly reads the spelling aloud incorrectly, the spelling will be considered correct if the speller shows his correct printed spelling to the other players and all other printed spelling attempts are crossed out.

The reader then announces if the word is spelled correctly and, if it is correct, the reader then shows the spelling to the other players so that they can verify that the word was spelled correctly. The speller then moves his playing piece on the game board. The difficulty level of the word spelled correctly is used to determine how many spaces the player moves his playing piece. A correct spelling of an EASIER spelling word allows the speller to move one space on the game board while a correct spelling of an INTERMEDIATE spelling word results in a two space move, and a correct spelling of a MORE DIFFICULT spelling word results in a three space move of the speller's playing piece. Alternative numbers of spaces can be utilized, as can other measurements of advancement in other embodiments. For example, a player can be awarded a higher number of points for a MORE DIFFICULT word than for an INTERMEDIATE word in a game wherein scores are based upon points.

If the speller spells the word incorrectly, his playing piece is not moved. The spelling card used by the speller, i.e. the used spelling card, is then placed face down in a discard pile to separate it from the unused spelling cards. The next player then takes his turn by rolling the die to determine his spelling word difficulty. The player who was just the speller then becomes the reader for the next speller's turn. The new reader draws the next card from the appropriate spelling deck and reads the appropriate spelling word to the next speller. Each player continues taking turns rolling the die to determine the difficulty of their spelling word to be spelled and spelling the words until all players have had one turn. After all players have had a chance to spell a word, they continue in the same order. If the spelling cards run out for any given spelling level during play, another one hundred spelling cards are randomly chosen from the spelling cards provided. In the event that all three hundred spelling cards in any given level are used during one game, the discarded spelling cards are reshuffled, and placed face down to be re-used as needed. In the event that a spelling word turns up twice in the same game after the spelling cards are re-shuffled, that card should be discarded and the next card should be used.

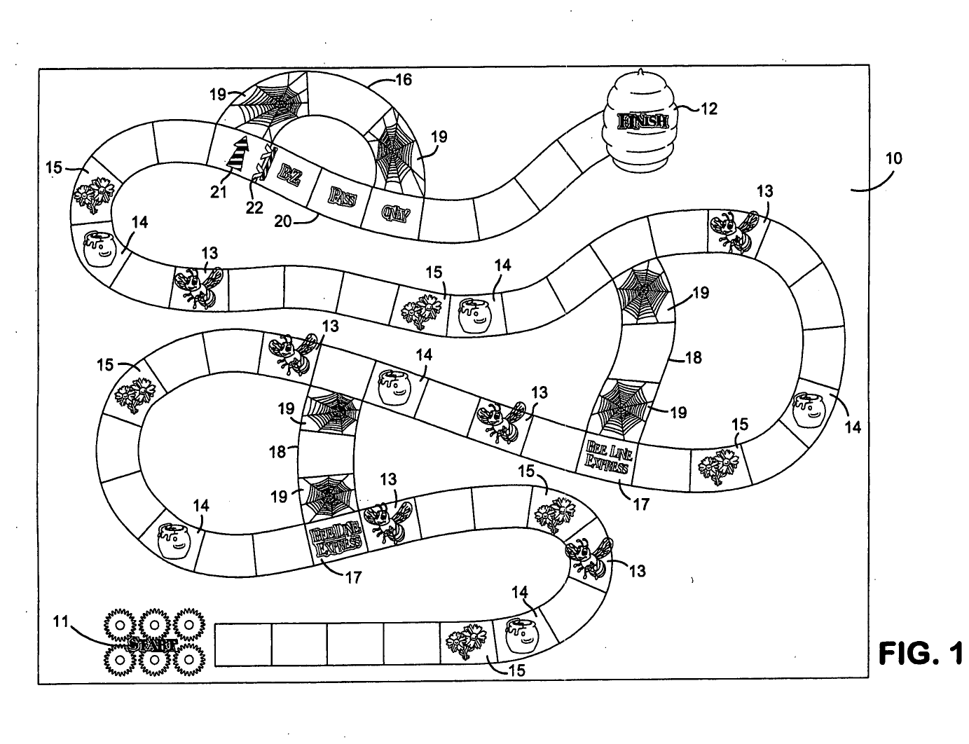

The object of the game is to be the first player to move from the START space to a FINISH space. The FINISH space is located on the upper right hand corner of the illustrated game board and is identified by an indicia, such as a bee hive in a tree. An embodiment of the present game board is shown in FIG. 1.

With reference to FIG. 1, the game board 10 comprises several game spaces beginning at the START space 11 and ending at the FINISH space 12. Some of these game spaces are identified as BONUS spaces which are distinguished by different indicia and are more fully described below. The illustrated embodiment has eighteen BONUS spaces. A number of these BONUS spaces are identified with an indicia of a bee and are called BEE spaces 13. When a player lands on a BEE space 13, he is required to randomly draw one of a plurality of cards that are known in the preferred embodiment as “BUZZLEBEE” Cards. Examples of the “BUZZLEBEE” Cards are shown in FIGS. 3 and 4. Each of the “BUZZLEBEE Cards” has instructions written on one side which directs the player's next playing piece movement, which is sometimes beneficial to the player, or sometimes detrimental.

Directions on the “BUZZLEBEE” Cards include 1) directing a player to move his playing piece to another BONUS space and follow the directions of the other BONUS space, 2) directing a player to go to the nearest space located on a “shortcut,” 3) directing a player to move to the space three spaces behind the leader, and 4) directing the player to send another player back a certain number of spaces. If a BUZZLEBEE card directs a player to move three spaces behind the leader, the player must move his playing piece three spaces behind the player who is closest to the FINISH space 12. However, if one of the BUZZLEBEE cards is drawn by the leader, the player must also follow the directions on the playing card and move back three spaces from where the player is when the playing card is drawn. If the BUZZLEBEE CARD directs a player to send another player back, the player can send the playing piece of a player of his choosing back five spaces. Players are moved back no matter where they are on the game board, even if they are on a BRIDGE or on the BEE-LINE EXPRESS. The BRIDGE and BEE-LINE EXPRESS are identified below. If the player who is sent back is less than five spaces from the START, he moves back to the START 11. If the player is sent back to another BONUS space, the player must also follow the rules of that BONUS space. Once all players on BONUS spaces have completed their turns, play resumes in normal order with the player to the left of the last speller. The purpose of the BONUS cards is to give a player who is far behind some hope of catching up, so that the player does not lose interest in playing.

There is at least one card, and preferably three cards, in the BONUS card deck identified as a B-Z PASS card, as shown in FIG. 4, which are used to give a player an advantage in by-passing a BRIDGE space 16 near the FINISH space 12.

Additional BONUS spaces on the game board include other indicia and upon landing on such spaces, a player must follow the directions for that particular BONUS space. In the preferred embodiment, some BONUS spaces include flower indicia and are identified as FLOWER spaces 15. If a player lands on a FLOWER space 15, the player advances his playing piece two spaces. In the preferred embodiment, other BONUS spaces include indicia of a honey pot and are identified as HONEY POT spaces 14. If a player lands on a HONEY POT space 14, the player is allowed an extra turn to roll the die and, therefore, an opportunity to spell another word.

As noted above, the game board comprises a plurality of shortcuts which allow a player to move ahead and bypass a number of spaces. The spaces comprise a continuous circuitous path, as shown in FIG. 1, wherein the spaces create loops on the right and left of the game board. The SHORTCUT spaces 18 comprise three spaces, a space with an indicia such as a spider web 19, a blank space and a second spider web space 19. These shortcuts are identified as “BEE-LINE EXPRESS” spaces 17. The “BEE-LINE EXPRESS” spaces 17 are accessed when a player reaches the space marked “BEE-LINE EXPRESS” which is positioned at the bottom of a SHORTCUT 18 as shown in FIG. 1. When a player moves to or past a “BEE-LINE EXPRESS” space 17, the player has the option of stopping at a “BEE-LINE EXPRESS” space 17 and moving across the SHORTCUT 18 on his next turn, or continuing the long way around the loop of the circuitous path.

Once a player elects to take the “BEE-LINE EXPRESS” SHORTCUT, there is no need to roll the die to determine his spelling word difficulty. Instead, the player must spell the next MORE DIFFICULT spelling word from his appropriate game level. The player moves across the SHORTCUT 18 only by spelling MORE DIFFICULT spelling words. Once the player correctly spells a MORE DIFFICULT spelling word, the player moves to the blank space on the shortcut between the two spider web spaces 19. The player cannot move onto a spider web space 19. Once the player has passed the first spider web space 19 the player must continue to move across the SHORTCUT 18 by spelling another MORE DIFFICULT word on the player's next turn. Until the player's game piece moves past the first spider web 19 onto the shortcut the player can change his or her mind and roll the die on his or her next turn and move along the loop on the circuitous path. The player's playing piece moves over the second spider web 19 only when the player correctly spells another MORE DIFFICULT spelling word, at which time the player moves one space forward onto the next space on the game board. On the player's next turn, the player follows the normal rules of movement of the game. In order to make the selection process, i.e. whether to take the SHORTCUT 18, more interesting, BONUS spaces such as those identified above, i.e. FLOWER spaces 15 and/or HONEY POT spaces 14, are placed along the loops of the path.

In the illustrated embodiment, there is a BRIDGE 16 near the FINISH 12 as shown in FIG. 1. The BRIDGE 16 has an upper level and a lower level. The upper level of the BRIDGE 16 is similar to the SHORTCUT spaces 18 and comprises a spider web space 19, a blank space and another spider web space 19. The lower level 20 of the BRIDGE 16 follows the regular game board path and comprises a number of spaces, preferably at least three spaces marked with an indicia, such as B-Z PASS ONLY. The space before the BRIDGE 16 is marked with an indicia such as an arrow 21 pointing in the direction of the upper level of the BRIDGE 16, or by some other method to indicate that it is a special space. This space is followed by a “barrier” 22 in the direction of the lower level of the BRIDGE which serves as a visual reminder that the space cannot be passed according to the normal game movement rules. When a player reaches the ARROW space 21, the player must stop unless the player has acquired one of the B-Z PASS cards available in the BUZZLEBEE card deck as shown in FIG. 4. If a player does not have a B-Z PASS card, he must move across the upper level of the BRIDGE 16. After landing on the ARROW space 21, the player must wait until his next turn to spell a MORE DIFFICULT spelling words to move past the first spider web on the upper level of the BRIDGE 16. A player on the BRIDGE 16 must continue to attempt to spell MORE DIFFICULT spelling words until he correctly spells a second MORE DIFFICULT spelling word. If the player correctly spells a second MORE DIFFICULT spelling word, the player moves over the second spider web 19 on the BRIDGE 16 and back onto the regular game board path. Players who have B-Z Pass cards do not need to move past the barrier of the upper level of the BRIDGE 16, but rather can move across the lower level of the BRIDGE 20 according to the regular rules of the game by handing in the B-Z PASS card that they previously obtained.

The illustrated board game and cards are provided only as examples. From the present description, one skilled in the art could design alternatives without departing from the scope of the present invention. For example, different game boards can be designed to appeal to the particular age level of the players, such as a first version for grades 1 through 4, and a second version for grades 5 through 8. These and/or adult board versions may also incorporate educational and ecological information about bees.

In another embodiment wherein more than two players are playing, a special optional rule will prevail. If the players decide to apply the special optional rule, when a player spells a word incorrectly, the player in last place is given an opportunity to “steal” that word by correctly spelling the word. This player is referred to herein as the “alternate speller.” The alternate speller must not be the reader, must not be the original speller and must be in the same game level as the original speller, or in a lower game level. If the player that is in last place is supposed to be the next reader, another player can read the card instead so that the alternate speller rule is available to the player in last place. A player that is on one of the spaces between the spider webs on the BEE-LINE EXPRESS or on either space on the BRIDGE is not eligible to be an alternate speller. A player on the first space of a BEE-LINE EXPRESS is eligible to be an alternate speller but may use a correctly spelled “stolen” word only to move around the loop along the regular spaces on the playing board, not across the BEE-LINE EXPRESS shortcut.

If there are two players tied for last place, each player must roll the die to determine who will be considered the first alternate speller. On a die where the different indicia are colors, priority of the colors corresponds to the level of difficulty, i.e. the highest colors will be the color that is designated for the MORE DIFFICULT words. If the players roll the same indicia on the die, there is a tie and they must roll the die again. An incorrect answer will not be penalized and the alternate player will still take his or her regular turn. If the first alternate speller does not spell the word correctly, then the player that is in next to last place, i.e. the second alternate speller, can attempt to spell the word. Similarly, if the second alternate speller misspells the word, each of the other eligible players can attempt to spell the word, in reverse order of their position on the game board until the word is spelled correctly or until all eligible players have had a chance, whichever occurs first. If an alternate speller correctly spells the misspelled word, he moves the number of spaces designated for the word.

When the players are of different game levels and different level spelling cards are being used, an alternate speller who is in a lower game level than the original speller and who correctly spells the misspelled word, will be awarded a one space bonus for each level that he is below the original speller. For example, if an alternate speller in Level 1 correctly spells a MORE DIFFICULT word from Level 2, the alternate speller moves his playing piece four spaces, i.e. three spaces for correctly spelling a MORE DIFFICULT word plus one additional space because the word is one level above the alternate speller's level. The alternate speller has the option to choose not to take the one additional space bonus, if he decides that to do so is not beneficial. The purpose of this rule is to make the game more competitive by mitigating the effect of the age advantage within each grade level, e.g. 3^{rd} graders versus 4^{th} graders competing within the same game level, i.e. Level 2. This rule allows the involvement of more than one player in the game on each word, gives the younger and/or less accomplished players more practice spelling words, and challenges younger players to attempt to spell more difficult words.

The winner of the present spelling game is the first player to reach the FINISH space. The final move made by a player to land on the FINISH space is preferably by an exact number of spaces. For example, if a player is two spaces away from the FINISH and rolls an indicia that would allow him more than two spaces then the player must wait until his next turn to roll the die again.

The reader will use the dictionary pronunciation guide, if the reader is not familiar with the correct pronunciation. The rules will also encourage parents to become involved as designated readers and will encourage the reader to show the playing card to the other players and ask for their help (except the speller and last place alternate speller) if the reader has a question about the word's pronunciation so that a proper pronunciation of the word can be made.

In another embodiment, the game can be played in teams, with each team taking one playing piece. A team can be identified by the color of the game piece, e.g. the “red” team or the “orange” team. The members of the team elect a team captain. During play, the teammates discuss the spelling of the word among themselves, and the captain then announces the team's final spelling answer.

Another embodiment of the present invention is directed to an electronic version comprising an annunciator to announce the spelling words. Use of the annunciator eliminates the need for a designated reader for the game or that the players take turns being the reader. It also allows the last player to be an “alternate speller” in the optional game of play without concern over whether the last player was the reader for that particular turn. In addition, the use of the electronic annunciator further sharpens the player's skill in word pronunciation because the players will not question the pronunciation of a word by a reader as may occur in a non-electronic version.

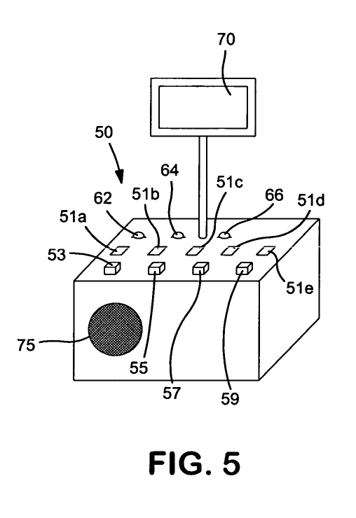

A preferred electronic embodiment shown in FIG. 5 comprises internal circuitry for randomly determining the difficulty of the word to be spelled. This embodiment comprises a row of five buttons 51a-51e for players to input the game level of the word to be announced and spelled by the player whose turn it is. This embodiment also comprises a button 53 which is depressed in order to have the device 50 announce a word. Upon depression of button 53, device 50 randomly chooses a word and announces the word. The difficulty level of the word is indicated by one of three lights wherein light 62 is yellow and indicates an EASIER word, a green light 64 indicates an INTERMEDIATE word, and a blue light 66 which indicates a MORE DIFFICULT word. If a player wishes to have a word repeated, a player can depress button 53 again and device 50 will repeat the word. In order to obtain a definition of the word, button 55 is depressed and device 50 will announce a definition or provide some other indication of the word's meaning.

After a player has spelled the word, upon depressing button 57 device 50 will provide an indication of the correct spelling of the word. According to this illustrated embodiment, that indication is provided audibly through speaker 75 and visibly on rotatable electronic screen 70, however, in alternative embodiments the correct spelling can be provided either audibly or visibly. Depressing button 53, device 50 will continue to announce the same word until the device has received input that a new word is desired by the depression of button 59. When it is time to move on to a different word, button 59 is depressed prior to the depression of button 53.

In another embodiment, the electronic annunicator further comprises circuitry for identifying machine-readable indicia such as a bar code reader. In this embodiment, the spelling cards are provided with some machine-readable indicia, such as a bar code. Such code may be on the same side of the spelling cards that shows the spelling words. Upon passing the spelling card through the bar code reader and the annunciator announces the appropriate word.

In yet another embodiment, the annunciator further comprises means for inputting a spelling word, which is then announced by the annunciator. This input means comprises a keyboard.

The electronic and mechanical details of the voice annunciator, the random card selector and circuitry involved in the electronic embodiment are not provided herein since they are within the level of skill of one of ordinary skill in the art.

Another embodiment of the present invention is directed to a game show embodiment wherein a game show host is the designated reader. This embodiment can be played by individual players or by teams. In one such embodiment, there are multiple categories of word difficulties, chosen by incorporating into the highest categories words included in the MORE DIFFICULT category of the board game as well as words used in the championship level of known national spelling bees. In this embodiment, contestants are asked to spell words chosen in the same manner as are the words included in the EASIER and INTERMEDIATE levels of the game in the earlier rounds of the competition for lower amounts of points and/or money and to progressively spell more difficult words as the game progresses, with the penalty of losing accumulated points or money if a word is misspelled. In one such embodiment, there are three contestants who initially have spell-off rounds requiring each player to spell one randomly chosen word of the same difficulty level in each round. A misspelling of any word by a player results in that player being removed from the game unless all other players also misspelled their word in that round, in which event another spell-off round would ensue. The last remaining player after the spell-off advances to the prize round of the game to earn points and/or money as described above. A computer game could also be designed to follow the same format.

In another embodiment, all three contestants spell a randomly selected word and the dollar and/or point value of a correctly spelled word is determined by the percentage of members of the studio audience and or viewers who spell the same word incorrectly, (e.g. if 75% of the viewers spell the word incorrectly the player earns $7,500 for correctly spelling the word or, if 25% of the studio audience/viewers spell the word incorrectly, the player earns $2,500 for correctly spelling the word. The viewer/studio_audience spelling of the word could be done by text messaging or by some other electronic means. The winning player for each game advances to play against two new contestants in the next game and continues to play until he or she lost. In one embodiment, the members of the studio audience can qualify as contestants for the next game by scoring the most number of points based upon their spelling answers in the previous game. Viewers can qualify for inclusion in the studio audience on the same basis.

In one internet-based embodiment of the game, players compete against each other by attempting to simultaneously spell the same randomly determined word within a pre-determined time limit (e.g. 15 seconds). A misspelled word prevents a player from being able to advance to the next randomly determined spelling word. The last one hundred players remaining would earn points in reverse order of their finish (e.g. one hundred points for first place, one point for 100^{th} place). Results would be tabulated daily with the top players being identified by their chosen code name.

While the various embodiments described herein have been described using an Americanized version of the English language, the present invention is not limited to use in English and can be played in other languages.

1. A method of playing a spelling game wherein players are required to spell words in order to advance in said game, comprising the steps of:
randomly selecting a word and a level of spelling difficulty to be communicated to a player for spelling, wherein said selecting step comprises selecting a word having a level of difficulty from a plurality of word collections wherein a first collection comprises words of a different level of spelling difficulty than a second collection;
communicating the selected word and the level of difficulty to the player;
providing a player with an opportunity to spell the randomly selected word; and
if the player correctly spells the selected word, advancing the player in the game, wherein the degree of advancement corresponds to the difficulty level of the selected word.

2. A method according to claim 1 wherein said level of difficulty is communicated to the player audibly.

3. A method according to claim 1 wherein said level of difficulty is communicated to the player visibly.

4. A method according to claim 1 wherein the randomly selected word is visibly communicated to a person other than the player who is to spell the word.

5. A method according to claim 1 further comprising the step of establishing at least one game level for at least one player.

6. A method according to claim 5 wherein said game level is selected from a plurality of possible game levels with each game level encompassing no more than two consecutive age or educational grade levels.

7. A method according to claim 6 wherein said plurality of possible game levels further comprises a separate adult game level.

8. A method according to claim 5 wherein each game level comprises no more than two consecutive age or educational grade levels for players in grades first through eighth.

9. A method according to claim 1 wherein only one player is given an opportunity to spell the selected word in any given turn.

10. A method according to claim 1 wherein a plurality of players are sequentially given an opportunity to spell the same selected word in any given turn according to a predetermined order.

11. A method according to claim 1 wherein a plurality of players are sequentially given an opportunity to spell the same selected word in any given turn according to a randomly selected order.

12. A method according to claim 1 wherein a plurality of players are simultaneously given an opportunity to spell the selected word.

13. A method of playing a spelling game wherein the players are required to spell words in order to advance in said game, comprising the steps of:
establishing at least one game level for at least one player;
randomly selecting a level of spelling difficulty for a word to be communicated to said player for spelling,
determining a word to be spelled by a player based upon said randomly selected level of difficulty, said determining step comprising identifying a word having the randomly selected level of difficulty from a plurality of words comprising different levels of spelling difficulty;
communicating the selected Word and the level of difficulty to the player;
providing a player with an opportunity to spell the randomly selected word; and
if the player correctly spells the selected word, advancing the player in the game, wherein the degree of advancement corresponds to the difficulty level of the selected word.

14. A method according to claim 13 wherein said identifying step comprises identifying one word from a card comprising a plurality of words of different levels of spelling difficulty.

15. A spelling game wherein players are required to spell words to advance in said game comprising:
a plurality of spelling cards, each spelling card comprising a plurality of spelling words having different levels of spelling difficulty and indicia indicating the level of said spelling difficulty for said words on each of said plurality of spelling cards, wherein said different levels of spelling difficulty are within no more than two consecutive age or educational grade levels;
means for randomly determining the level of spelling difficulty of a spelling word to be spelled by a player.

16. A spelling game according to claim 15 further comprising a game board and a plurality of playing pieces.

17. A spelling game according to claim 15 wherein each of said spelling cards comprises at least three spelling words and indicia indicating the different levels of spelling difficulty of said words.

18. A spelling game according to claim 15 wherein said spelling words are categorized into said different levels of spelling difficulty by at least one of the following criteria: the word length, the number of syllables, the number of silent letters, the number of double letters, the possible spellings caused by sounds that can be spelled by at least two different letters or combinations of letters and the number of homonyms.

19. A spelling game according to claim 18 wherein said criteria comprises how often the average player of the game level would typically read, write, hear or speak the word in the course of the player's studies, recreational activities and/or normal daily interactions.

20. A spelling game according to claim 18 wherein said criteria comprise the degree to which the same sounds and/or letter combinations in the word are contained in other words in the same game level or at lower game levels of the same game.

21. A spelling game according to claim 15 wherein said spelling words are categorized into said different levels of spelling difficulty by a plurality of the following criteria: the word length, the number of syllables, the number of silent letters, the number of double letters, the possible spellings caused by sounds that can be spelled by at least two different letters or combinations of letters, and the number of homonyms.

22. A spelling game according to claim 15 wherein said words comprising different levels of spelling difficulty are selected from known spelling lists for no more than two consecutive age or educational grade levels and a separate Adult level.

23. A spelling game according to claim 15 wherein said consecutive age or educational levels are divided into Level 1—Grades 1 and 2; Level 2—Grades 3 and 4; Level 3—Grades 5 and 6; Level 4—Grades 7 and 8; and Level 5—Adult.

24. A spelling game according to claim 15 wherein said different groups of words comprise a first level, a second level and a third level of spelling difficulty, and wherein a majority of the words categorized in said first level of spelling difficulty comprise words that can be spelled phonetically, or which can be spelled correctly by a player with knowledge of phonics and the non-phonetic rules of the language of the word to be spelled.

25. A spelling game according to claim 15 wherein said different groups of words comprise a first level, a second level and a third level of spelling difficulty, and wherein a majority of the words categorized in said second level of spelling difficulty comprise words which suggest one alternate, incorrect spelling to a player who has knowledge of phonics and the non-phonetic rules of the language of the word to be spelled.

26. A spelling game according to claim 15 wherein said different groups of words comprise a first level, a second level and a third level of spelling difficulty, and wherein a majority of the words categorized in said third level of spelling difficulty comprise words which suggest a plurality of alternate, incorrect spellings to a player who has knowledge of phonics and the non-phonetic rules of the language of the word to be spelled.

27. A spelling game according to claim 15 wherein each of said different levels of spelling difficulty of said plurality of spelling words on said spelling cards are identified by different indicia on said spelling cards.

28. A spelling game according to claim 27 wherein said different indicia comprise different colors.

29. A spelling game according to claim 15 wherein said determining means comprises one die.

30. A spelling game according to claim 29 wherein said die comprises a plurality of sides, each side comprising indicia which corresponds to a level of spelling difficulty of said spelling words on said spelling cards.

31. A spelling game according to claim 15 further comprising a plurality of decks of spelling cards, each deck comprising a plurality of spelling cards wherein each of said plurality of decks comprises spelling words for no more than two consecutive age or educational grade levels.

32. A spelling game according to claim 15 further comprising a plurality of bonus playing cards.

33. A spelling game according to claim 32 wherein said bonus playing cards provide directions for movement of said playing pieces during play of said spelling game.

34. A spelling game according to claim 16 wherein a player is able to take a shortcut across at least a portion of the game board by correctly spelling one or more of the highest level difficulty words.

35. A spelling game according to claim 16 wherein a player is required to spell one or more of the highest level difficulty words to move past a certain designated space unless the player has acquired a BONUS card allowing the player to proceed.

36. A spelling game according to claim 16 wherein said BONUS cards include cards which may be either beneficial or detrimental to the player's advancement.

37. A spelling game according to claim 36 wherein said beneficial cards comprise cards which direct a player to move forward to a certain designated space on the game board or to move forward a set number of spaces, or to move another player back a set number of spaces or which direct a player to move to a space a designated number of spaces behind another player.

38. A spelling game according to claim 17 wherein said detrimental cards comprise cards which direct players to move back to a certain designated space on the game board, to move back a set number of spaces or to lose a turn.

39. A spelling game according to claim 16 wherein said BONUS cards include cards which may be either beneficial or detrimental to the player's advancement depending upon the player's position on the game board.

40. A spelling game according to claim 39 wherein said cards that may be either beneficial or detrimental dependent upon the player's position on the game board comprise cards which direct a player to go to the nearest of certain designated spaces on the game board.
